(19) United States
(12) Patent Application Publication
(10) Pub. No.: US 2026/0088310 A1
(43) Pub. Date: Mar. 26, 2026

(54) SHAPED BATTERY CELL AND METHOD OF MANUFACTURE

(71) Applicant: Anthro Energy, Inc., San Jose, CA (US)

(72) Inventors: Dory Kramer, San Jose, CA (US); Joseph K. Papp, San Jose, CA (US); David George Mackanic, San Jose, CA (US)

(73) Assignee: Anthro Energy, Inc., San Jose, CA (US)

(21) Appl. No.: 19/338,421

(22) Filed: Sep. 24, 2025

Related U.S. Application Data
(60) Provisional application No. 63/698,349, filed on Sep. 24, 2024.

(51) Int. Cl. H01M 6/06; H01M 50/105; H01M 50/107

(52) U.S. Cl. CPC H01M 6/06; H01M 50/105; H01M 50/107; H01M 2300/0082; H01M 2300/0085

(57) ABSTRACT

A method for forming a shaped battery can include: adding electrolyte to a dry battery cell, shaping the battery cell, relieving stress and/or strain from the battery cell, curing the electrolyte, and/or injection moulding a thermoplastic or thermoset around the battery cell. A battery cell can include a cathode, an anode, a separator disposed between the cathode and the anode, a gel polymer electrolyte, an overmoulded housing surrounding the cathode, the anode, the separator, and the gel polymer electrolyte, where the battery cell comprises a non-zero radius of curvature about at least 1 axis.

### CROSS-REFERENCE TO RELATED APPLICATIONS

This application claims the benefit of U.S. Provisional Application No. 63/698,349 filed 24 Sep. 2024, which is incorporated in its entirety by this reference.

### TECHNICAL FIELD

This invention relates generally to the battery cell field, and more specifically to a new and useful system and method in the battery cell field.

### BRIEF DESCRIPTION OF THE FIGURES

FIG. 1 is a flow chart representation of an example of a method for manufacturing (or shaping) a battery cell.

FIG. 2 is a schematic representation of an example of a battery.

FIG. 3 is a schematic representation of an example of shaping a battery cell.

FIGS. 4A-4C are schematic representations of examples of electrodes within a shaped battery cell.

FIG. 5 is a schematic representation of an example of a battery cell with curvature about more than one axis (e.g., a twisted battery cell).

FIG. 6 is a schematic representation of an exemplary moulded battery cell (in this instance shaped like a temple from a pair of glasses).

FIG. 7 is a schematic representation of an example of a method for forming a moulded battery cell.

FIG. 8 is a schematic representation of an exemplary cured gel electrolyte.

FIG. 9 is a schematic representation of exemplary polymeric precursor structures that can be used to form a polymer or gel matrix for a polymer electrolyte.

FIG. 10 is a schematic representation of an example of forming an overmoulded battery cell.

FIGS. 11A and 11B are schematic representations comparing examples of insert moulding on an exemplary gel electrolyte battery and an exemplary liquid electrolyte battery.

FIG. 12 is a schematic representation of an example of forming an electrode stack using moulding (e.g., via wetting a dry electrode stack within a cavity or mould, wetting the dry electrode stack with a polymer electrolyte precursor, and curing the polymer electrolyte precursor within the mould; where in some variants the mould can be a pouch), releasing the electrode stack from the mould, and overmoulding the electrode stack (e.g., using injection moulding). Note that in some variants, between releasing the electrode stack and overmoulding, the electrode stack can (but does not have to be) bent, twisted, and/or have any other suitable shape conferred thereto.

### DETAILED DESCRIPTION

The following description of the embodiments of the invention is not intended to limit the invention to these embodiments, but rather to enable any person skilled in the art to make and use this invention.

### 1. Overview

As shown in FIG. 2, a battery can include current collectors, one or more anode, one or more cathode, one or more separator, an electrolyte, and/or other suitable components within an enclosure (e.g., housing, casing, etc.). The battery preferably has curvature in at least one axis in each component. However, the battery can be shaped in any manner. In a variant, the shape (e.g., curvature) can be retained (e.g., locked in place) by the electrolyte (e.g., a cured polymer electrolyte, gel electrolyte, etc.). In another variant, the shape (e.g., curvature) can be a moulded shape (e.g., retained within a moulded housing).

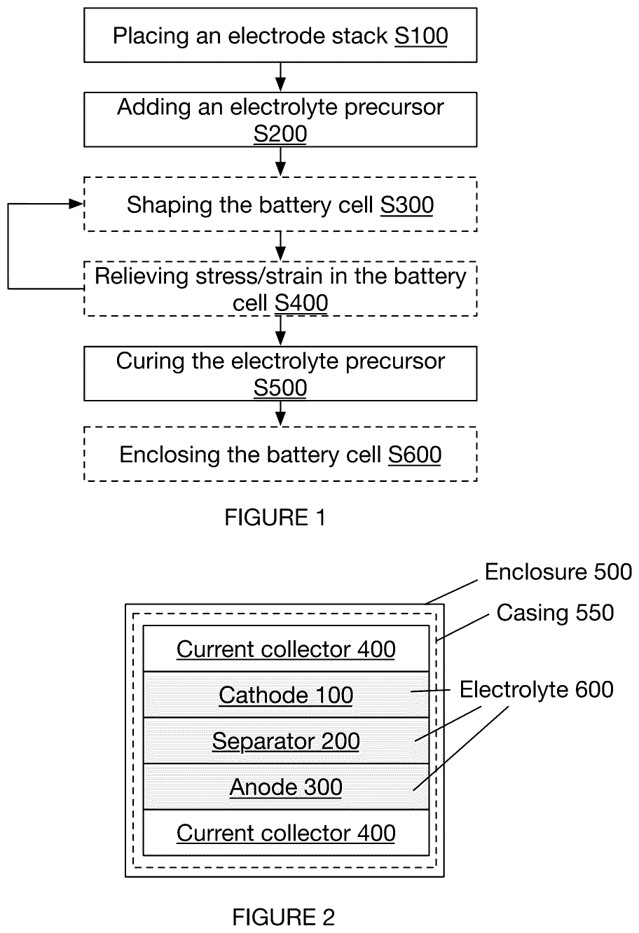

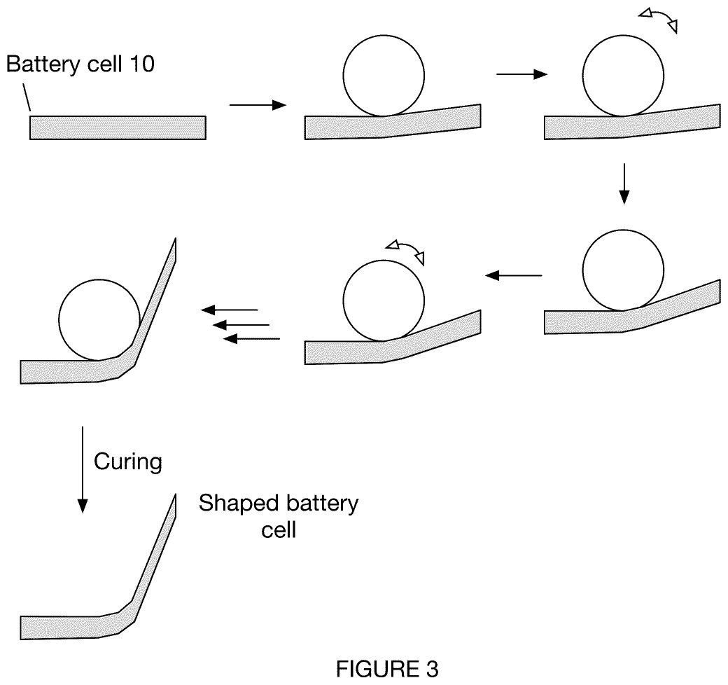

As shown in FIG. 1, a method for forming a shaped (particularly but not exclusively curved) battery can include: forming a dry (e.g., lacking electrolyte) electrode stack S100, adding electrolyte to the electrode stack S200, shaping the electrode stack S300, relieving stress and/or strain from the electrode stack S400, curing the electrolyte S500, enclosing the electrode stack S600, and/or other suitable steps (e.g., sealing the electrode stack, charging the electrode stack, etc.).

Embodiments of the battery preferably have a form that can match or be directly integrated into a system (e.g., a system to receive power from the battery, load) without requiring dedicated space or integrations for the battery (e.g., without a battery compartment). These embodiments are sometimes referred to as structural batteries as the battery cells (and/or battery modules or battery packs) are integrated into and/or form part of the battery-powered systems physical structure. Some visionary examples of such integrations could include batteries shaped as and/or integrated into airfoils, landing gear, vehicle roofs, vehicle frames, glasses bridge, glasses temple, glasses rims, helmet shell, helmet cradle, handles, enclosures (e.g., dust enclosures), device cases (e.g., laptop, smartphone, etc.), watch bands, fasteners (e.g., integrated into screws, nails, etc.), and/or other similar integrations (e.g., to fill a void or other unused or underutilized space within a device or container).

### 2. Technical Advantages

Variants of the technology can confer one or more advantages over conventional technologies.

First, variants of the technology can form batteries with semi-arbitrary shapes, where the batteries can hold or maintain the shape. Particular interest is given to curvature in the shape of the battery (e.g., curvature along one axis of the battery typically the long axis, curvature in a plurality of axes, etc.); however, additional or alternative structures can also be realized such as serpentine, helical, spiral, spherical (or segments derived from a sphere such as a dome, spherical wedge, etc.), angular, annular, and/or other shapes or geometries. In examples of these variants, a gel electrolyte can be used to set the battery shape and hold the battery in the target shape (e.g., a cured gel can provide the mechanical properties to retain a battery shape).

Second, variants of the technology can reduce a risk of unwanted deformation during that battery shaping process. For instance, by gradually introducing curvature (or other shape) with contemporaneous (and/or alternating with) rolling, buckling and/or other unwanted deformation can be avoided.

Third variants of the technology can have a reduced risk of battery degradation from the formation of the battery shape. For instance, variants of the technology can mitigate a risk of electrical shorting and/or thermal runaway by leveraging excess (in terms of relative length) electrode material for electrodes that are further from the center of curvature. In these examples, the amount or extent of excess can depend on a target curvature. These examples can also provide a technical advantage of having better areal matching between cathodes and anodes (as variants that do not include the overhang will have regions that where an electrode is pulled back and does not have opposing electrode material orthogonally across the separator).

Fourth, variants of the technology can expand the design choices for a system that includes a battery. For instance, rather than including a battery compartment, the battery can form part of or an entirety of a frame or skeleton (potentially affording more volume for other designs, enabling a size or thickness reduction of the system, increasing a total battery capacity available to the system, etc.).

Fifth, variants of the technology can enable higher viscosity electrolyte precursor usage. For example, by leveraging tubular tabs arranged orthogonally (or at other suitable intersecting angles) to the electrodes (rather than parallel), higher viscosity electrolytes can be introduced (e.g., injected into) the battery (e.g., through the tubular tab). These higher viscosity electrolytes can be advantageous for ionic conductivity, mechanical properties, adhesion, and/or can have other suitable advantageous properties.

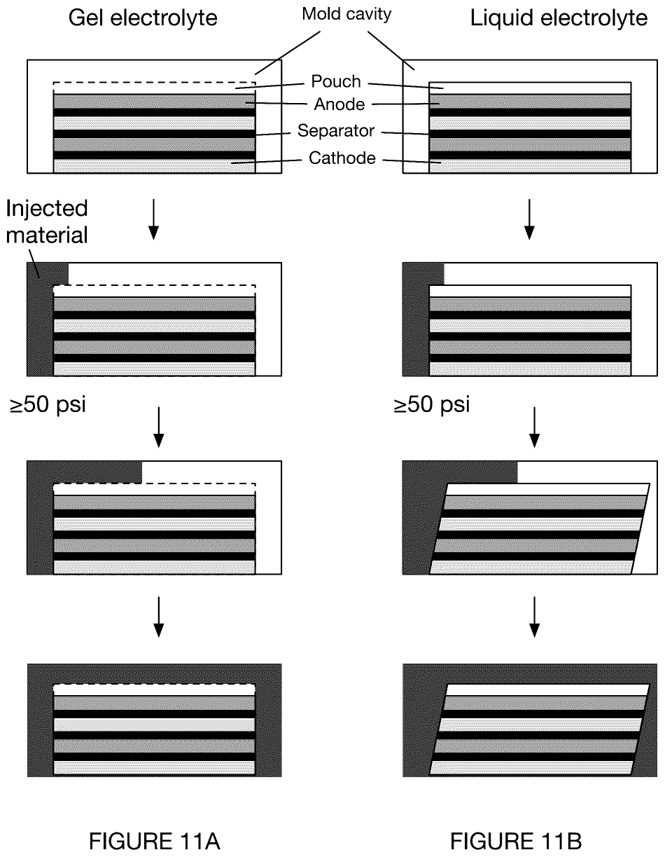

Sixth, variants of the technology can enable overmoulding or insert moulding of a battery cell and/or electrode stack. For instance (as shown for example in FIG. 11), the use of electrode stacks and/or battery cells with gel or polymer electrolyte can withstand the pressures used to inject and/or differential pressures that occur when injecting a molten material (e.g., metal, glass, elastomer, thermoplastic, thermoset, etc.) into a mould, thereby enabling insert moulding and/or overmoulding around the battery cell and/or electrode stack. In contrast (as shown for example in FIG. 11), battery cells that have a wet electrolyte can result in active material delamination, deformation, movement (e.g., sliding, slipping, translation, etc.), and/or other undesirable changes in the battery cell.

However, further advantages can be provided by the system and method disclosed herein.

### 4. Battery

As shown in FIG. 2, a battery can include current collectors, one or more anode, one or more cathode, one or more separator, an electrolyte, and/or other suitable components within an enclosure (e.g., housing, casing, etc.). When the enclosure is not included, the remaining components can be referred to as an electrode stack (where a dry electrode stack can exclude electrolyte and a wet electrode stack can include electrolyte). The battery preferably has curvature in at least one axis (i.e., each component includes such curvature). The axis can be located at any arbitrary point of the battery. For instance, an axis could be located at a center of mass of the battery (and/or component thereof), a threshold distance from an edge of the battery (and/or component thereof), and/or can otherwise be arranged. However, the battery can be shaped in any manner.

These batteries are often pouch cells (e.g., utilize a sealed pouch to contain the battery components such as wound pouch cells, stacked pouch cells, z-folded pouch cells, etc.). Alternatively phrased, a casing (e.g., enclosure, housing, etc.) of the battery typically has a pouch format. However, these batteries can additionally or alternatively be cylindrical cells, prismatic cells, cells of unusual form factors, and/or other suitable battery cells and/or have other suitable casing. The casing can be made of metal (e.g., steel, stainless steel, etc.), ceramics, plastic, wood, glass, and/or any suitable materials. For instance, in some variants, the battery cell can exclude a pouch but the electrode stack can be encased in a thermoset or thermoplastic.

These batteries are typically (but not necessarily) polyelectrode battery cells (e.g., include two or more cathodes and/or two or more anodes). Often the electrodes are double sided (except for terminal electrodes which can be double sided to simplify machinery or single sided to reduce material waste as one side will not have an opposing electrode to effect electrochemical reactions). As such each electrode is typically associated with (e.g., disposed opposing) two counter electrodes. However, the electrodes can be single sided. For instance, a battery cell can include 3 cathode and 2 anodes, 3 anodes and 2 cathode, 9 cathodes and 8 anode, 9 anodes and 8 cathodes, 25 cathodes and 24 anodes, 25 anodes and 24 cathodes, 100 cathodes and 99 anodes, 100 anodes and 99 cathodes, and/or any suitable number or range of electrodes.

Variations of the battery cell can have an elastic modulus (e.g., flexural modulus) between about 200 MPa and 20 GPa. However, the battery cell can have other suitable elastic modulus (e.g., based on polymer electrolyte composition, based on polymer electrolyte degree of polymerization, etc.).

Variations of the battery cell preferably have a maximum swelling (during normal use) of 10% (i.e., a thickness increases by less than 10% of the initial thickness of the battery cell).

The casing is preferably sealed (e.g., hermetically sealed to hinder or prevent ingress of materials from the environment into the battery which can result in battery degradation, fire, etc.). For instance, the casing can be hermetically sealed using a polymeric sealant (e.g., polyurethane, acrylics, butyl polymers, silicone polymers, polysulfides, silicon-curable polyurethane, silicon-curable polyether, silicon-curable polyisobutylene, silicon-curable acrylics, etc. such as thermoplastic, thermosetting, etc. polymers). In some variations, a cured polymer electrolyte (such as described below) can be used to form the seal. However, additionally or alternatively, a metal, polymer, ceramic, cermet, glass, and/or other material (e.g., composites thereof) can be used and/or the casing can otherwise be sealed (e.g., using gaskets, metal-metal joints, etc.). In some variants, one or more current collector tab can be retained within the seal (e.g., as disclosed for example in U.S. patent application Ser. No. 19/205,251 titled ‘FLEXIBLE BATTERY’ filed 12 May 2025 which is incorporated in its entirety by this reference).

The current collector can function as a support for an electrode and/or conduct electrons into and out of the electrode. For instance, a cathode current collector can support a cathode (e.g., cathode materials) and an anode current collector can support an anode (e.g., anode materials). The cathode current collector and anode current collector can be the same or different. The current collectors can be foil, foam, mesh, carbon coated, wire, plate, and/or be any type of current collector. The current collectors are typically made from aluminium (particularly common for the cathode), copper (particularly common for the anode), nickel, titanium, and/or stainless steel. However, the current collectors can be made of any material (e.g., carbonaceous materials such as carbon nanotubes, graphite, graphene, etc.; brass; conductive polymers such as PPy, PANi, polythiophene, etc.; etc.).

In some variants (particularly when thick current collectors are used such as current collectors with greater than about 20 μm thickness), the current collectors can additionally or alternatively function to improve an elastic modulus of the battery cell and/or retain a shape of the battery cell (in addition to and/or in combination with the electrolyte). In related variants, the electrodes can form structural components within an engineered beam (e.g., I-beam, T-beam, C-beam, central post, etc.).

In some variants (as shown for instance in FIG. 6), the cathode and/or anode tabs can be arranged orthogonal to the electrodes and/or intersecting the electrodes at a non-zero angle. In these variants, the tabs will generally include insulating coatings and/or electrically insulated regions to prevent cell shorting across the current collectors. For instance, the anode tab(s) is preferably electrically insulated at portions where it crosses the cathode(s) (and optionally separator(s)) and similarly for the cathode tab(s) and the anode(s). The tabs of this variant can be columns (e.g., wires, rods, etc.), plates, tubes (e.g., hollow columns), and/or can have any suitable morphology. In variants that leverage hollow tube tabs, the tabs could be used themselves as a feed for electrolyte injection (e.g., using pressure to inject the electrolyte, which can enable higher viscosity electrolyte formulations). Additionally or alternatively, these variants can use the hollow tube tabs for degassing (e.g., during polymer curing, during battery operation to limit swelling, etc.). In one example, a first tab could be used to inject electrolyte (e.g., flood the battery cell with electrolyte) and a second tab could be used for degassing (e.g., to avoid clogging of the first tab preventing or hindering degassing).

The cathode (e.g., material thereof) functions to undergo reduction during discharge (e.g., electrons enter the cathode during discharge and leave the cathode during charging). The cathode can include binders (e.g., to bind the cathode active material together, to bind the cathode active material to the current collector, etc.), cathode active material (e.g., the material that participates electrochemically), conductive material (e.g., to increase an electrical conductivity within the cathode active material, to improve shuttling of electrons between the current collector and the cathode active material, etc.), and/or can include any suitable material(s). The cathode active material is preferably a lithium-containing active material (e.g., lithium nickel cobalt manganese oxide (NMC, NCM) such as NMC 622, NMC 811, NMC532, NMC111, etc.; lithium iron phosphate (LFP); lithium manganese iron phosphate (LMFP); lithium nickel manganese spinel (LNMO); lithium nickel cobalt aluminium oxide (NCA); lithium manganese oxide (LMO); lithium cobalt oxide (LCO); lithium titanate (LTO); lithium transition metal borates such as borophosphates (BPO), borosilicates (BSiO), borosulfates (BSO), etc.; lithium vanadium phosphate (LVP); etc.). However, the cathode active material can additionally or alternatively include sodium-containing cathode active material (e.g., sodium ion battery), potassium-containing cathode active material (e.g., potassium ion battery), magnesium-containing cathode active material (e.g., magnesium ion battery), calcium-containing cathode active material (e.g., calcium ion battery), zinc-containing cathode active material (e.g., zinc ion battery), aluminium-containing cathode active material (e.g., aluminium ion battery), and/or any suitable cathode active material can be used. The cathode active material is typically particulate (e.g., nanoparticle, mesoparticles, macroparticle, etc.), but can form thin films and/or any morphology. Examples of binders include: polyvinylidene fluoride (PVDF), styrene butadiene copolymer (SBR), carboxymethyl cellulose (CMC), polyacrylic acid (PAA), poly(vinyl alcohol) (PVA), humics, poly(3,4-ethylenedioxythio-phene)-polystyrenesulfonate (PEDOT:PSS), chitosan, alginate, combinations or blends thereof, and or other suitable binder(s). Examples of conductive additives include: carbon black, carbon nanotubes, graphite, graphene, fullerenes, carbon fiber (VGCF), Super P Li, S—O, KS-6, KS-15, SFG-6, SFG-15, 350G, acetylene black, Kezin black, and/or any suitable conductive additive or combination of conductive additives can be used.

The anode (e.g., material thereof) functions to undergo oxidation during battery discharge (e.g., electrons leave the anode during discharge and enter the anode during charging). The anode can include binders (e.g., to bind the anode active material together, to bind the anode active material to the current collector, etc. analogous to a binder as described above for a cathode), anode active material (e.g., the material that participates electrochemically), conductive material (e.g., to increase an electrical conductivity within the anode active material, to improve shuttling of electrons between the current collector and the anode active material, etc. analogous to a conductive additive as described above for a cathode), and/or can include any suitable material(s). The anode active material can be carbon based (e.g., graphite, graphitic carbon, carbon fibers, carbon nanotubes, carbon spheres, carbon nanorods, etc.), alloy materials (e.g., aluminium, tin, magnesium, silver, antimony, their alloys, etc.) conversion-type materials (CTAM such as transition-metal sulfides, oxides, hydroxides, phosphides, nitrides, carbides, fluorides, selenides, chalcogenides, oxalates, niobates, etc.), silicon materials, combinations thereof (e.g., mixtures of graphite and silicon), lithium metal, and/or any suitable anode active material. The anode active material is typically particulate (e.g., nanoparticle, mesoparticles, macroparticle, etc.), but can form thin films and/or any morphology. In some variants, the battery does not include an anode.

The separator functions to electrically isolate the anode from the cathode (e.g., prevent electrical short circuiting) while allowing ions (e.g., Li⁺) to pass between the cathode and the anode. The separator can also function to improve the safety of the battery (e.g., by closing pores above a threshold temperature thereby shutting off ion transport) and/or can otherwise function. The separator can be porous, fibrous (e.g., a web, sheet, mat, etc. or oriented or random fibers), and/or have any suitable structure. The porosity of the separator is typically between about 30-50%. However, the porosity can be lower than 30% or higher than 50%. The separator can be made of polymers (e.g., polyolefin such as polyethylene, polypropylene, polybutene, polymethylpentene, etc.; poly(tetrafluoroethylene); poly(vinyl chloride); etc.), nonwoven fibers (e.g., cotton, nylon, glass, polyester, etc.), natural substances (e.g., wood, rubber, asbestos, etc.), ceramics (e.g., lithium lanthanum titanate, lithium lanthanum zirconate, lithium lanthanum zirconium tantalate, lithium aluminium germanium phosphate, lithium aluminium silicon phosphorous titanium oxide, etc.), and/or of any suitable material.

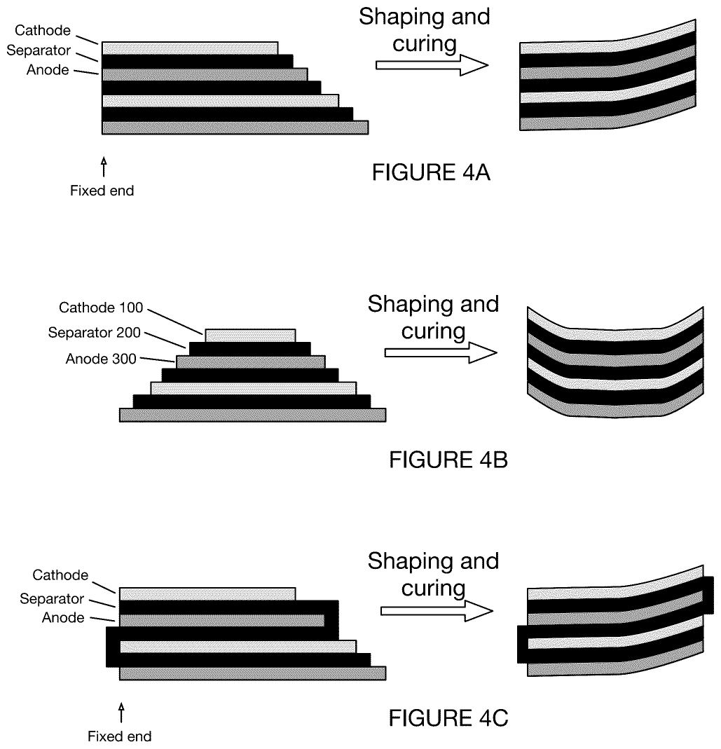

In some variants (as shown for example in FIG. 4C), a single separator can wrap around electrodes of a multi-electrode battery cell (e.g., in a Z-fold geometry). In other variants (as shown for example in FIG. 4A), a plurality of individual separators can be disposed between each pair of electrodes. However, other suitable separator configurations can be realized (e.g., a separator that surrounds each anode or cathode).

The electrolyte functions to transport ions between the cathode and the anode (e.g., through the separator). Additional functionalities can be conferred to the electrolyte (e.g., solid-electrolyte interface (SEI) formation, flame retardant, flame suppression, overcharge protection, H₂O and/or HF concentration control, retaining or holding a structure of the battery, thermal transport or thermal conductivity of the battery, moisture tolerance or moisture sensitivity, hinder moisture transport, etc.). After curing, the electrolyte is preferably a gel electrolyte (e.g., a solvent, salt, additives, etc. contained within a polymer matrix). However (after curing, in the absence of curing, during curing, during addition to the battery, etc.), the electrolyte can be a solid (e.g., polymeric solid), liquid, and/or can be any suitable state.

The electrolyte can include one or more polymer(s) (and/or polymer precursors such as monomers or oligomers or other formulation components as described which can be cured or otherwise treated to form the polymer or gel), one or more solvent(s) (e.g., ethylene carbonate (EC), diethyl carbonate (DEC), dimethyl carbonate (DMC), ethyl methyl carbonate (EMC), propylene carbonate (PC), vinylene carbonate (VC), dimethoxyethane (DME), diethyl ether, tetrahydrofuran (THF), methyl formate (MF), ethyl formate (EF), methyl propionate (MP), methyl butanoate, ethyl formate (EF), ethyl acetate (EA), ethyl propionate (EP), ethyl butanoate, propyl formate, propyl acetate (PA), propyl propionate (PP), propyl butanoate, glyme, diglyme, triglyme, tetraglyme, etc.), one or more salt(s) (e.g., lithium hexafluorophosphate (LiPF₆), lithium hexafluoroarsenate (LiAsF₆), lithium tetrafluoroborate (LiBF₄), lithium perchlorate (LiClO₄), lithium tetracyanoborate (LiB(CN)₄) lithium bis(fluorosulfonyl)imide (LiFSI), lithium bis(trifluorosulfonyl)imide (LiTFSI), lithium tris(trifluoromethanesulfonyl)methide (LiTFSM), lithium bis(oxalate)borate (LiBOB), lithium difluoro(oxalato)borate LiDFOB, lithium fluoroalkylphoshpates (LFAP such as lithium tris(pentafluoroethyl)trifluorophosphate), lithium-cyclo-difluoromethane-1,1-bis(sulfonyl)imide (LiDMSI), lithium-cyclo-hexafluoropropane-1,1-bis(sulfonyl)imide (LiHPSI), lithium-cyclo-hexafluoropropane-1,1-bis(sulfonyl)imide (LiBETI), lithium difluoro(oxalato)borate (LiDFOB), lithium bis(monofluoromalonato)borate (LiBFMB), lithium 4,5-dicyano-1,2,3-triazolate (LiDCTA), lithium 2-trifluoromethyl-4,5-dicyanoimidazole (LiTDI), lithium 4,5-dicyano-2-(pentafluorylethyl) imidazole (LiPDI), etc.), one or more additive(s) (e.g., fluoroethylene carbonate (FEC), trivinylcyclotriboroxane (tVCBO), VC, LiDFOB, LiBOB, 1,3,2-dioxathiolane-2,2-dioxide (DTD), vinyl acetate (VA), 2-vinyl pyridine (VP), sulfone, ethyl methyl sulfone, tetramethyl sulfone (TMS), prop-1-ene-1,3-sulfone (PES), 1,3-propane sultone (PS), cyclic sulfate, dioxolone, 5-methyl-4-((trifluoromethoxy)methyl)-1,3-dioxol-2-one, phenyl boronic acid glycol ester (PBE), 5-methyl-4-((trimethylsilyloxy)methyl)-1,3-dioxol-2-one, trimethylphosphate (TMP), triethylphosphate (TEP), tributylphosphate (TBP), triphenylphosphate (TPP), tris(2,2,2-trifluoroethyl)phosphate (TFP), methyl P,P-bis(2,2,2-trifluoroethyl)phosphate (BMP), trimethylphosphite (TMPi), tris(2,2,2-trifluoroethyl)phosphite (TTFPi), dimethyl methyl phosphate (DMMP), diethyl ethylphosphate (DEEP), bis(2,2,2-trifluoroethyl)methylphosphate (TFMP), bis(2,2,2-trifluoroethyl)ethylphosphate (TFEP), hexa(methoxy)cyclotriphosphazene (HMOCPN), (ethoxy)pentafluorocyclotriphosphazene (PFPN), (phenoxy)pentafluorocyclotriphosphazene (FPPN), Phoslyte™, etc.), and/or any suitable material(s). Examples of polymer precursors include: aliphatic acrylates (e.g., isobornyl acrylate, hexadecyl acrylate, t-butyl acrylate, silsesquioxane acrylates, methacrylic acid, aliphatic urethane acrylates, etc.), aliphatic methacrylates (e.g., methyl methacrylate, benzyl methacrylate, ethyl methacrylate, isopropyl methacrylate, hydropropyl methacrylate, isobutyl methacrylate, t-butyl methacrylate, cyclohexyl methacrylate, isobornyl methacrylate, phenyl methacrylate, trimethylsilyl methacrylate, T6 silsesquioxane methacrylate, T8 silsesquioxane methacrylate, T10 silsesquioxane methacrylate, T12 silsesquioxane methacrylate, aliphatic urethane methacrylates, etc.), aliphatic diacrylates (e.g., aliphatic diurethane diacrylates, aliphatic polycarbonate diureido diacrylate, polyether diureido diacrylate, polyester diureido diacrylate, polycarbonate polyether diureido diacrylate, polycarbonate polyester diureido diacrylate, polyether polyester diureido diacrylate, polycarbonate polyether polyester diureido diacrylate, polycarbonate diacrylate, polyether diacrylate, polyester diacrylate, polycarbonate polyether diacrylate, polycarbonate polyester diacrylate, polyether polyester diacrylate, polycarbonate polyether polyester diacrylate, etc.), aliphatic dimethacrylates (e.g., aliphatic diurethane dimethacrylates, polycarbonate dimethacrylate, polyether dimethacrylate, polyester dimethacrylate, polycarbonate polyether dimethacrylate, polycarbonate polyester dimethacrylate, polyether polyester dimethacrylate, polycarbonate polyether polyester dimethacrylate, polyether polyester diureido dimethacrylate, polycarbonate polyether polyester diureido dimethacrylate, polycarbonate diureido dimethacrylate, polyether diureido dimethacrylate, polyester diureido dimethacrylate, polycarbonate polyether diureido dimethacrylate, polycarbonate polyester diureido dimethacrylate, etc.), aliphatic triacrylates (e.g., aliphatic triurethane triacrylates, polycarbonate triacrylate, polyether triacrylate, polyester triacrylate, polycarbonate polyether triacrylate, polycarbonate polyester triacrylate, polyether polyester triacrylate, polycarbonate polyether polyester triacrylate, polycarbonate triureido triacrylate, polyether triureido triacrylate, polyester triureido triacrylate, polycarbonate polyether triureido triacrylate, polycarbonate polyester triureido triacrylate, polyether polyester triureido triacrylate, polycarbonate polyether polyester triureido triacrylate, trimethylolpropane ethoxylate triacrylate, trimethylolpropane triacrylate, trimethylolpropane propoxylate triacrylate, glycerol propoxylate triacrylate, pentaerythritol triacrylate, zirconium bromonorbornanelactone carboxylate triacrylate, etc.), aliphatic trimethacrylates (e.g., aliphatic triurethane trimethacrylates, polycarbonate trimethacrylate, polyether trimethacrylate, polyester trimethacrylate, polycarbonate polyether trimethacrylate, polycarbonate polyester trimethacrylate, polyether polyester trimethacrylate, polycarbonate polyether polyester trimethacrylate, polycarbonate triureido trimethacrylate, polyether triureido trimethacrylate, polyester triureido trimethacrylate, polycarbonate polyether triureido trimethacrylate, polycarbonate polyester triureido trimethacrylate, polyether polyester triureido trimethacrylate, polycarbonate polyether polyester triureido trimethacrylate, trimethylolpropane ethoxylate trimethacrylate, trimethylolpropane trimethacrylate, trimethylolpropane propoxylate trimethacrylate, glycerol propoxylate trimethacrylate, pentaerythritol trimethacrylate, zirconium bromonorbornanelactone carboxylate trimethacrylate, etc.), aliphatic tetracrylates (e.g., aliphatic tetraurethane tetraacrylates, polycarbonate tetraacrylate, polyether tetraacrylate, polyester tetraacrylate, polycarbonate polyether tetraacrylate, polycarbonate polyester tetraacrylate, polyether polyester tetraacrylate, polycarbonate polyether polyester tetraacrylate, polycarbonate tetraaureido tetracrylate, polyether tetraaureido tetracrylate, polyester tetraaureido tetracrylate, polycarbonate polyether tetraaureido tetracrylate, polycarbonate polyester tetraaureido tetracrylate, polyether polyester tetraaureido tetracrylate, polycarbonate polyether polyester tetraaureido tetracrylate, pentaerythritol tetraacrylate, 3-(N,N,N,N tetrakis(propionate) hexanediamino)-2-hydroxypropyl acrylate, etc.), aliphatic tetramethacrylates (e.g., aliphatic tetraurethane tetramethacrylates, polycarbonate tetramethacrylate, polyether tetramethacrylate, polyester tetramethacrylate, polycarbonate polyether tetramethacrylate, polycarbonate polyester tetramethacrylate, polyether polyester tetramethacrylate, polycarbonate polyether polyester tetramethacrylate, polyether polyester tetraureido tetramethacrylate, polycarbonate polyether polyester tetraureido tetramethacrylate, polycarbonate tetraureido tetramethacrylate, polyether tetraureido tetramethacrylate, polyester tetraureido tetramethacrylate, polycarbonate polyether tetraureido tetramethacrylate, polycarbonate polyester tetraureido tetramethacrylate, pentaerythritol tetramethacrylate, 3-(N,N,N,N tetrakis(propionate) hexanediamino)-2-hydroxypropyl methacrylate, etc.), aliphatic pentacrylates (e.g., dipentaerythritol pentaacrylate, aliphatic pentaurethane pentaacrylates, etc.), aliphatic pentamethacrylates (e.g., dipentaerythritol pentamethacrylate, aliphatic pentaurethane pentamethacrylates, etc.), aliphatic hexacrylates (e.g., aliphatic hexaurethane hexacrylates, polycarbonate hexacrylate, polyether hexacrylate, polyester hexacrylate, polycarbonate polyether hexacrylate, polycarbonate polyester hexacrylate, polyether polyester hexacrylate, polycarbonate polyether polyester hexacrylate, polycarbonate hexaaureido hexacrylate, polyether hexaaureido hexacrylate, polyester hexaaureido hexacrylate, polycarbonate polyether hexaaureido hexacrylate, polycarbonate polyester hexaaureido hexacrylate, polyether polyester hexaaureido hexacrylate, polycarbonate polyether polyester hexaaureido hexacrylate, dipentaerythritol hexaacrylate, etc.), aliphatic hexamethacrylates (e.g., aliphatic hexaurethane hexamethacrylates, polycarbonate hexamethacrylate, polyether hexamethacrylate, polyester hexamethacrylate, polycarbonate polyether hexamethacrylate, polycarbonate polyester hexamethacrylate, polyether polyester hexamethacrylate, polycarbonate polyether polyester hexamethacrylate, polyether polyester hexaureido hexamethacrylate, polycarbonate polyether polyester hexaureido hexamethacrylate, polycarbonate hexaureido hexamethacrylate, polyether hexaureido hexamethacrylate, polyester hexaureido hexamethacrylate, polycarbonate polyether hexaureido hexamethacrylate, polycarbonate polyester hexaureido hexamethacrylate, dipentaerythritol hexamethacrylate,etc.), aliphatic cyanoacrylates (e.g., methyl cyanoacrylate, ethyl cyanoacrylate, propyl cyanoacrylate, isopropyl cyanoacrylate, butyl cyanoacrylate, allyl cyanoacrylate, methoxyethyl cyanoacrylate, T6 silsesquioxane cyanoacrylate, T8 silsesquioxane cyanoacrylate, T10 silsesquioxane cyanoacrylate, T12 silsesquioxane cyanoacrylate, etc.), aliphatic acrylamides (e.g., acrylamide, N,N dimethyl acrylamide, t-butyl acrylamide, etc.), styrenes (e.g., styrene, methylstyrene, dimethylstyrene, trimethylstyrene, t-butyl styrene, ethoxystyrene, acetoxystyrene, etc.), methacrylonitrile, aromatic acrylates, aromatic methacrylates, examples as shown for instance in FIG. 9, and/or other suitable monomers or mixture thereof.

In preferred variants, an average functionalization (e.g., on a per mole basis relative to combined number of moles monomers, where functionalization refers to a number of polymerizable moieties on a molecule or available in the polymer-forming components of the electrolyte precursor) is between about 1.5 and 2.1. As a first illustrative example, a composition that includes only difunctional monomers (e.g., diacrylates, dimethacrylates) would have an average functionalization of 2. As a second illustrative example, a composition the includes 50% by moles monofunctional monomers (e.g., monoacrylates or monomethacrylates) and 50% by moles trifunctional monomers (e.g., triacrylates or trimethacrylates) would similarly have an average functionalization of 2. As a third illustrative example, a composition that includes 80% by moles of monofunctional monomers (e.g., monoacrylates or monomethacrylates) and 20% by moles of hexafunctional monomers (e.g., hexaacylates, hexamethacrylates) would have an average functionalization of 2. Other mixtures can achieve similar resulting average functionalization.

A thermal conductivity of the electrolyte (precured electrolyte or postcured electrolyte) is preferably greater than about 0.2 W/m/K (e.g., 0.3 W/m/K, 0.5 W/m/K, 0.6 W/m/K, 0.7 W/m/K, 0.9 W/m/K, 1 W/m/K, 1.3 W/m/K, 1.5 W/m/K, 1.7 W/m/K, 2 W/m/K, 2.5 W/m/K, 3 W/m/K, 3.5 W/m/K, 4 W/m/K, 4.5 W/m/K, etc.). Higher values (e.g., greater than about 1 W/m/K) of thermal conductivity can be beneficial for improving curing (e.g., reducing polymer curing time, improving curing uniformity, reducing a temperature gradient, etc.).

Examples of polymer precursors and/or polymer electrolytes can include those described and/or resulting from the curing process as described in U.S. patent application Ser. No. 19/307,908 titled ‘SYSTEM AND METHOD FOR IMPROVED BATTERY STRUCTURAL PROPERTIES’ filed 22 Aug. 2025, U.S. patent application Ser. No. 18/443,716 titled ‘GEL ELECTROLYTE COMPOSITION FOR A BATTERY AND A METHOD OF IMPLEMENTATION’ filed 16 Feb. 2024, and/or U.S. patent application Ser. No. 18/779,553 titled ‘FLEXIBLE BATTERY’ filed 22 Jul. 2024, each of which is incorporated in its entirety by this reference.

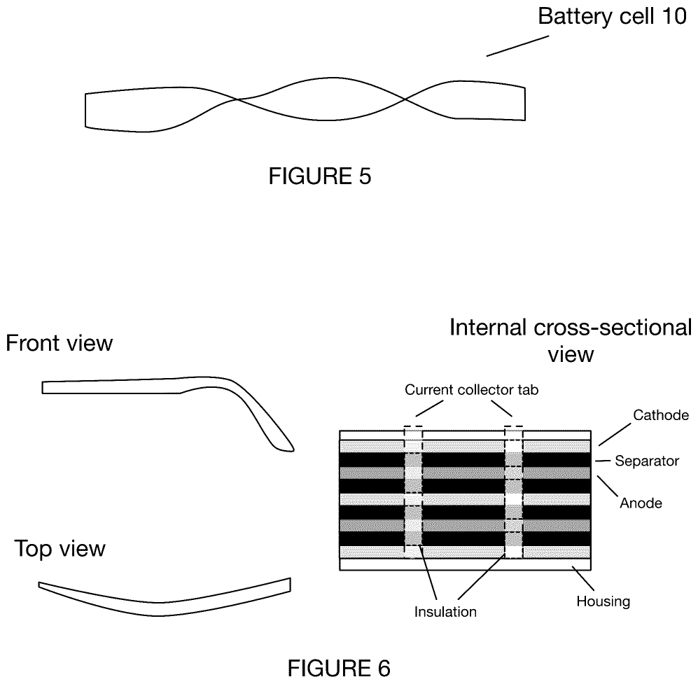

The battery is preferably designed with a nonlevel shape. Typically, all of the components will have the nonlevel shape (i.e., the current collectors, electrodes, and separator are all shaped). However, a subset of components may not have the nonlevel shape. Examples of nonlevel shapes included: curved (e.g., including a constant or nonconstant radius of curvature; as shown for instance in FIG. 4A, FIG. 4B, or FIG. 4C; etc.), twisting (e.g., as shown for example in FIG. 5), angular (e.g., zig-zag, bent at a sharp angle, etc.), sinusoid, chevron shape, spherical or hemispherical, cylindrical (where the electrodes of the electrode stack can be wound such as having a helical, spiral, double spiral, etc.; where each electrode within an electrode stack can be cylindrical with increasing radius; etc.) and/or other similar patterns (e.g., including repetitions of peaks and/or valleys preferably with rounded turning points). While the shape will typically depend on an application (e.g., system the battery is integrated into), the shape can additionally or alternatively depend on the battery size (e.g., total battery capacity, battery length, battery width, battery thickness, etc.), a battery material (e.g., anode material, cathode material, separator material, electrolyte material, etc.), stress or strain (e.g., flexion) anticipated to be exerted on the battery, an impact expected to occur to the battery, battery operating parameters (e.g., depth of discharge during cycling, charging rate, etc.), and/or other suitable properties. Within curved segments, the radius of curvature is often between 1 mm and 1 m, but can have almost any non-zero value. However, in some variants, a flat battery cell (and/or electrode stack) can be used (e.g., a flat battery cell can be overmolded). However, any radius of curvature can be used (inclusive of cases where the curvature varies or is not constant).

In some variants, the radius of curvature can be different in different directions (e.g., infinite in one axis and finite in another axis, two distinct values in different axes to form an elliptical surface or saddle point, continuously varying at different points, etc.). Relatedly, in some variants, only a subset of the battery is nonlevel (e.g., curved, twisted, etc.) while the rest of the battery remains level (as shown for example in FIG. 4A or FIG. 4C). However, any suitable segments can have any suitable shape.

Often, the battery cells will have at least one region that is rigidly held together (as shown for instance in FIG. 4A or FIG. 4C). For instance, the battery components can be adhered together, welded together, and/or otherwise be fixedly attached together (e.g., using strapping tape). Frequently this region is proximal tabs of the battery. However, the fixed region can otherwise be arranged. In variants that include these fixed regions, the fixed region is preferably not curved (or otherwise have nonflat shape) such as there is a spatial buffer of at least a few millimeters (or longer) that is substantially flat. These variants can be beneficial for maintaining a safety of the battery (e.g., when the fixed region can be used to help mitigate a risk of electrical shorting and/or thermal runaway).

In the final shaped battery, the battery components (e.g., electrodes, separators, etc.) are preferably aligned (e.g., the electrodes are aligned and have matching lengths or sizes which can be beneficial for optimizing for specific and/or volumetric energy density, decreasing a risk of detrimental processes, etc.). However, other component geometries can be realized (e.g., using a separator to wrap around electrodes may alleviate the desire to overlap the components). In some variants, this alignment can be achieved by using terraced electrode stacks (e.g., electrode stacks where successive electrodes and/or separators of the stack can have differing lengths and/or widths when the electrode stack is level).

### 5. Method

As shown in FIG. 1, a method for forming a shaped (particularly but not exclusively curved) battery can include: forming a dry (e.g., lacking electrolyte) battery cell S100, adding electrolyte to the battery cell S200, shaping the battery cell S300, relieving stress and/or strain from the battery cell S400, curing the electrolyte S500, enclosing the electrode stack and/or battery cell S600, and/or other suitable steps (e.g., sealing the battery cell, charging the battery cell, etc.).

The method preferably functions to form a shaped and/or overmoulded battery cell (e.g., a battery cell as described above), preferably a battery cell that retains its shape absent external forces. Steps of the method can be performed sequentially, concurrently, contemporaneously, and/or with any suitable timing. The method can be performed as a batch process, a continuous process, and/or any suitable combination of processes.

Forming a dry electrode stack S100 can function to form and/or obtain an electrode stack that does not include electrolyte (e.g., by depositing cathode and/or anode material on a substrate such as from a slurry, drying the cathode and/or anode material, calendaring the cathode and/or anode material, building an electrode stack by contacting an anode and a cathode across a separator optionally more than once to form a target number of layers). Note that a dry electrode stack may include a pouch (or other casing) in which case it might be referred to as a dry battery cell. Additionally or alternatively, S100 could include inserting the electrode stack into a pouch (or other housing), where the pouch and/or housing can help to create a contained volume for the electrolyte while a liquid (e.g., before curing). For instance, a dry electrode stack can be purchased, anode and/or cathode active materials can be deposited on (e.g., from a slurry, paste, solution, colloid, etc.) a substrate (e.g., a current collector) and sandwiched together with a separator disposed therebetween (with other suitable steps such as drying, calendering, etc.), and/or the dry electrode stack can otherwise be formed. The dry electrode stack can be sealed (in which case the seal can be broken to perform S200) and/or unsealed. The dry electrode stack is preferably received flat (e.g., planar). However, the dry electrode stack can include a preformed shape (e.g., intermediate shape to the final shape, matching a target geometry, etc.).

In some variants, the components (e.g., electrodes and separator) of the dry electrode stack (and/or battery cell) can be sequentially oversized (e.g., each electrode and/or separator is preferably sequentially larger or smaller than the prior electrode and/or separator, as shown for example in FIG. 4A or FIG. 4B, etc.). The oversizing can, for example, depend on the radius of curvature to be achieved. However, the amount of oversizing can depend on other aspects of the shape of the battery cell, the size of the battery cell, the battery chemistry (or chemistry of components thereof), stresses (e.g., mechanical stress, thermal stress, etc.) the battery cell is expected to experience, a target N:P ratio between adjacent electrodes within an electrode stack and/or battery cell, and/or other suitable properties. As a specific example, the oversizing difference between a smallest and largest electrode can be between about 0.1 mm and 10 mm (where the largest electrode will be the electrode at an outer diameter of a radius of curvature for example). However, other suitable oversizing (in the received electrode stack or battery cell) can be realized and/or the electrodes can have the same size (e.g., where the electrode substrate can translate, lengthen or compress, etc. to accommodate the shape changes during subsequent steps). The oversizing (e.g., terracing) can be in a single dimension (e.g., to accommodate curvature in a single axis) or a plurality of dimensions (e.g., to accommodate curvature in more than one axis). As a first example (as shown for instance in FIG. 4B), an electrode stack can be terraced with a step pyramid and/or ziggurat-like shape. As a second example (as shown for instance in FIG. 4A), an electrode stack can be terraced with a stair-shape. However, other terracing and/or oversizing can be used.

In some variants, the amount of oversizing can depend on the electrolyte and/or electrolyte state. For instance, a battery cell using a liquid electrolyte (or intended to use a liquid electrolyte during a final application) can be oversized by at least about 1 mm (in a plane of the electrode stacks) and about 0.1 mm in an axis perpendicular to the electrode stacks. As another example, a battery cell and/or electrode stack using a gel electrolyte (or intended to use a gel electrolyte during a final application) can be oversized by at least about 0.3 mm (in a plane of the electrode stacks) and about 0.1 mm in an axis perpendicular to the electrode stacks. However, other suitable oversizing can be used.

In some variants (particularly, but not exclusively, for terraced electrodes and/or separators such as those of FIG. 4A, FIG. 4B, or FIG. 4C), the battery electrodes can be coated (e.g., spray coated) with electrolyte (and/or polymer precursor thereof) and the coating can be cured (e.g., via local application of heat such as using an IR local heat source). These variants can be beneficial for decreasing translation of the electrodes and/or separators (e.g., lock the battery electrodes and/or separator in place to facilitate further battery handling). However, other materials may be used to similar effect.

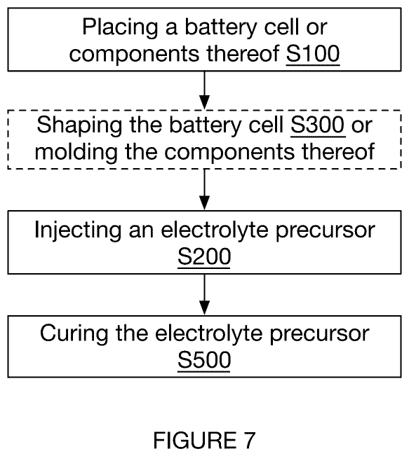

In some variants (as shown for instance in FIG. 7), S100 could include moulding (e.g., where the mould acts as a housing or case of the battery) and/or shaping the dry battery cell. For instance, the dry battery cell (and/or cured battery cell) can be stamped, cut, and/or otherwise have a suitable shape imparted there on. In another variant, the electrode stack (and/or electrode(s) or separator(s) thereof) can be cured or formed within a mould (e.g., cavity, pouch, etc.), removed (e.g., ejected) from the mould (e.g., after curing), and placing the shaped electrode stack into a mould (e.g., to form a housing around the electrode stack).

Adding electrolyte to the electrode stack (and/or battery cell) S200 functions to introduce electrolyte (e.g., an electrolyte or a precursor that can form the electrolyte as described above, an electrolyte or electrolyte precursor as disclosed in U.S. patent application Ser. No. 19/307,908 titled ‘SYSTEM AND METHOD FOR IMPROVED BATTERY STRUCTURAL PROPERTIES’ filed 22 Aug. 2025, U.S. patent application Ser. No. 18/443,716 titled ‘GEL ELECTROLYTE COMPOSITION FOR A BATTERY AND A METHOD OF IMPLEMENTATION’ filed 16 Feb. 2024, and/or U.S. patent application Ser. No. 17/423,712 titled ‘DYNAMICALLY-BONDED SUPRAMOLECULAR POLYMERS FOR STRETCHABLE BATTERIES’ filed 16 Jul. 2021, each of which is incorporated in its entirety by this reference) into the electrode stack and/or battery cell. The electrolyte is preferably added in a liquid state (e.g., as an electrolyte solution, precured solution, precured polymer-forming solution, etc.). Electrolyte in the liquid state (or in a partially cured state such that it is not fully solidified, can still flow, etc. such as a solution, slurry, paste, slip, colloid, suspension, etc.) can provide a technical advantage of acting as a lubricant within a battery cell (e.g., facilitating movement of electrodes and/or separator within a battery cell or electrode stack during S300 or S400). However, the electrolyte can be added in a solid state (e.g., fully cured, partially cured, etc.) and/or in any suitable state. Typically, the electrode stack will be contained within a housing or casing (e.g., a pouch) during S200. However, S200 can be performed with a free electrode stack (e.g., depending on a viscosity of the electrolyte solution, electrolyte state, etc.)

The electrolyte can be poured, injected, pipetted, syphoned, pumped, and/or added to the electrode stack (and/or battery cell) using other suitable transfer processes. In some variants, the electrolyte can be transferred into the electrode stack and/or battery cell at or near atmospheric pressure (e.g., with little or no back pressure applied). In these variants, the viscosity of the electrolyte solution is preferably less than about 50 cP. In other variants (e.g., in examples of moulded or to be moulded electrode stacks or battery cells, electrode stacks or battery cells with current collectors not found on the ends such as shown in FIG. 6, etc.), the electrolyte can be injected with a greater back pressure (e.g., with a back pressure exceeding atmospheric pressure). These variants can be beneficial for improving the wettability and/or loading of higher viscosity electrolyte solutions (e.g., electrolyte precursors with viscosity exceeding 50 cP such as 100 cP, 200 cP, 300 cP, 500 cP, 700 cP, 1000 cP, values or ranges therebetween, etc.). However, other suitable approaches can be used to load the electrode stack and/or battery cell with electrolyte.

In some variants, vacuum pulsing, electrowetting (e.g., applying a tap charge during wetting, prior to complete wetting, etc.), can/or other suitable techniques can be used to improve a wetting of the dry battery components with the electrolyte solution.

In some variants, a gradient can be formed in the elastic modulus of the electrolyte (and thus the resulting cell). In some examples, these variations in elastic modulus can be directly or indirectly responsible for the shape of the battery. As a first example, the composition of the electrolyte can spatially vary. As a second example, the local degree of polymerization can vary (e.g., by applying a gradient in the curing polymer conditions of S500, based on a gradient in polymerization initiator and/or inhibitor, etc.). However, other suitable gradients can be formed (e.g., in S200, in S500, etc.).

S200 preferably includes sealing the battery cell to hinder (e.g., prevent) egress of electrolyte solution (e.g., prior to curing) from and/or ingress of atmosphere (e.g., water, oxygen, etc.) into the battery cell. The battery cell can be sealed using a plastic seal (e.g., adhesive), weld, braze, and/or any suitable combination of (preferably hermetic) seal(s). In some variations, the electrolyte (or components thereof such as the polymer or polymeric precursors) could be used to form the seal. In other variations, the electrolyte (or components thereof such as the polymer or polymeric precursors) could limit moisture transport and thereby improve moisture tolerance of the battery cell (and as such the housing may not need to be hermetically sealed).

Shaping the electrode stack and/or battery cell S300 functions to induce or introduce curvature (and/or other suitable shape) into the electrode stack and/or battery cell. S300 is preferably performed iteratively with and/or contemporaneously with S400. However, S300 can be performed before S400 (e.g., the electrode stack and/or battery cell can be fully shaped prior to performing S400 optionally with a repetition of S300 to retouch the shape after S400) and/or with any suitable timing. S300 is preferably performed before S500 (so that the cured polymeric electrolyte can function to retain the induced shape). However, S300 can be performed contemporaneously with S500 (e.g., a curing mechanism can be applied at the same time as a shaping mechanism is used) and/or after S500.

S300 can be performed using benders (e.g., roll benders, die benders, die beaders, roll benders, ram benders, compression benders, press brakers, plate rollers, mechanical benders, hydraulic benders, etc.), formers (e.g., coiners, electrohydraulic formers, electromagnetic formers, explosive formers, extruders, hydroformers, stampers, punch, swager, etc.), smoothers (e.g., deburrers), and/or other suitable tools. As a first specific example, a electrode stack and/or battery cell (e.g., flat or incompletely shaped) can be rolled to induce curvature in the battery cell. As a second specific example, a electrode stack and/or battery cell can be cut to form a target shape (e.g., to match a mould).

Relieving stress and/or strain from the electrode stack and/or battery cell S400 functions to reduce deformation and/or damage to (e.g., tearing perforation, etc.) of the electrode stack and/or battery cell (e.g., the current collectors, substrate, housing, pouch, separator, etc.) during shaping the electrode stack and/or battery cell. For instance, S400 can function to reduce or eliminate buckling, bowing, wrinkling, warping, tearing, and/or other deformations or degradation that can occur as the electrode stack and/or battery cell is being shaped (e.g., during S300). As such S400 is preferably performed either contemporaneously with and/or iteratively with S300. However, S400 can be performed after S300 (e.g., to release deformation resulting from S300) and/or can be excluded from some variants of the method (e.g., for moulded battery cells, for battery cell applications where less than a threshold deformation occurs in the electrode stack and/or battery cell, etc.). S400 can additionally or alternatively function to stretch or compress electrodes (e.g., improve an alignment between the electrodes), and/or can otherwise function.

As a specific example of S400, rollers can move over a surface of the electrode stack and/or battery cell (e.g., acting to massage out wrinkles or other deformation from the battery cell). For subsequent iterations, the same or greater pressure can be applied using the rollers to relieve the stress and/or strain from the battery cell as it is being shaped. However, additionally or alternatively, vibratory stress relief, thermal stress relief (e.g., annealing), shot peening, laser peening, burnishing, impact treating, and/or other suitable processes can be used for S400.

Curing the electrolyte S500 functions to convert a liquid electrolyte solution (e.g., polymeric precursors thereof) to a solid (also referred to as polymer, gel-like, gel, etc.). The electrolyte is preferably cured after the electrode stack and/or battery cell has been shaped. However, in some variants, the electrolyte can be cured while the electrode stack and/or battery cell is being shaped (e.g., rollers or other pressure mechanisms using in S300 and/or S400 can be heated, configured to apply an electrical potential, etc. to the electrolyte contemporaneously with, iteratively with, etc. shaping or relieving stress and/or strain from the battery cell). After S500, the electrode stack and/or battery cell preferably retains its shape in the absence of an external pressure or force.

The electrolyte is preferably thermally cured (e.g., by heating the electrolyte to a temperature between 50° C. and 100° C. However, additionally or alternatively, the electrolyte can be electrochemically cured, optically cured, electromagnetically cured (e.g., UV curing, gamma-ray curing, visible light curing, etc.), spontaneously cured, cured via a phase transition, mechanical curing (e.g., pressure or force induced curing), and/or cured in another suitable manner.

The electrode stack and/or battery cell is preferably fixtured during curing (e.g., to retain a shape of the electrode stack and/or battery cell prior to a target degree of curing). However, the electrode stack and/or battery cell can be otherwise retained in any manner during curing.

In some variants (particularly but not exclusively when thermal curing is performed), the separator can soften during S500 providing an additional and/or alternative source for maintaining the electrode stack and/or battery cell shape. For instance, PVDF can soften at a temperature around 110° C. to potentially provide adhesive benefits to the electrode stack and/or battery cell (potentially at a cost to the ionic conductivity through the separator).

After curing, the electrode stack and/or battery cell preferably (but does not necessarily) undergoes a degassing step to remove excess gas (e.g., resulting from the polymerization reaction, resulting from battery formation, etc.) from the battery cell.

In some variants, after curing an electrode stack can be removed from a housing (e.g., a pouch). These variants can be beneficial as the housing does not contribute significantly to the capacity of the battery cell, but will decrease the gravimetric and/or volumetric capacity of the battery cell. The housing (e.g., pouch) can be removed, for instance, via etching, opening (e.g., via cutting) and extracting (e.g., removing) the electrode stack from the housing, and/or other suitable approaches to open the housing can be used.

Enclosing the electrode stack and/or battery cell S600, functions to encase the electrode stack and/or battery cell within an enclosing material (typically but not necessarily forming a hermetic seal). Typically. S600 is performed on a cured electrode tack and/or battery cell (e.g., as produced in S500). Using a cured electrode stack and/or battery cell can provide a technical advantage as the improved adhesion between layers or materials of a cured electrode stack and/or battery cell will hinder or prevent translation and/or deformation of the electrode stack and/or battery cell during encapsulating material addition. Moreover, using a cured electrode stack can enable a bare (i.e., no housing) electrode stack to be encased within the material, whereas a liquid electrolyte would typically require a housing to be able to be encased within the material.

S600 is typically performed using injection moulding (e.g., insert moulding, overmoulding, multi-material injection moulding, etc.). For example, the electrode stack and/or battery cell (e.g., shaped electrode stack and/or battery cell, cured electrode stack and/or battery cell, electrode stack and/or battery cell from S400, electrode stack and/or battery cell from S500, etc.) can be placed within a mould volume of an injection mould, liquid encapsulating material can be injected into the mould volume, the injected encapsulating material can solidify and/or harden (during which bonds between the encapsulating material and the electrode stack, housing, gel electrolyte, etc. may form), and ejecting the encapsulated electrode stack and/or battery cell from the mould volume. In some variants, this process may be performed twice (e.g., to ensure that all surfaces of the electrode stack and/or battery cell are encapsulated). However, the gel electrolyte (and/or substrates of the electrode stack and/or battery cell) may enable a surface of the electrode stack and/or battery cell to be exposed to environment (e.g., not sealed within the encapsulating material). In other variants, one or more of spray coating, dip coating, vapor deposition (e.g., chemical vapor deposition, physical vapor deposition, etc.), vacuum deposition, spin coating, sutter coating, slurry coating, 3D printing, and/or other suitable processes.

Typically, the encapsulating material surrounds the electrode stack and/or battery cell by a normal distance of at most about 0.1-5 mm. As one specific example, for a battery cell that includes liquid electrolyte, the normal distance is preferably at least about 1 mm. As a second specific example, for a battery cell that has a gel electrolyte, the normal distance is preferably at least 0.1 mm (e.g., 0.2 mm, 0.3 mm, 0.5 mm, etc.). However, smaller and/or larger distances may be used.

The injected material is typically introduced at a temperature above the melting temperature of the encapsulating material. For instance, for polymeric encapsulating material, the encapsulating material can be introduced at a temperature between about 100 and 350° C. However, other temperatures can be used. In these variants, the gel electrolyte may provide additional benefits to the electrode stack and/or battery cell as the gel electrolyte may enhance thermal conduction within the electrode stack and/or battery cell thereby decreasing a risk of thermal shock or damage to the electrode stack and/or battery cell.

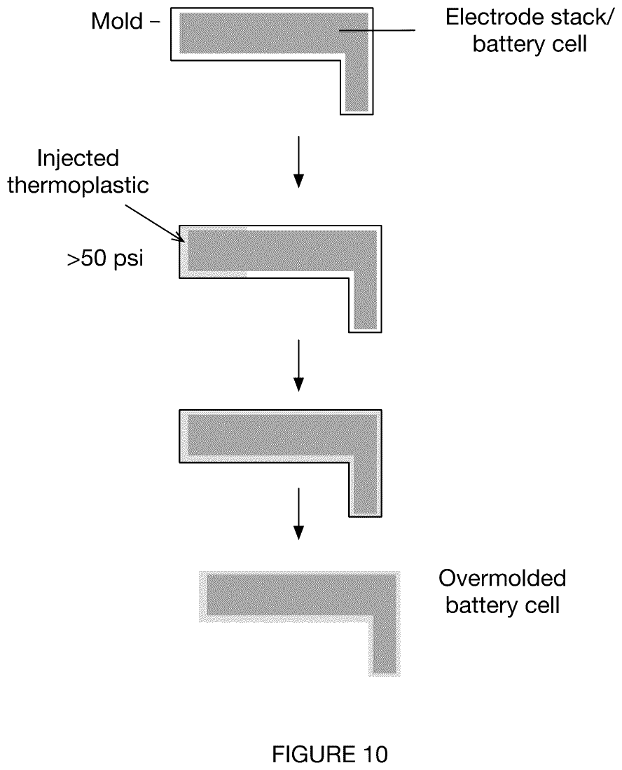

Often, injected material has a back pressure (as shown for example in FIG. 10, where back pressures can meet or exceed 50 psi, 75 psi, 100 psi, 150 psi, 200 psi, 250 psi, 300 psi, 500 psi, 750 psi, 1000 psi, 1500 psi, 2000 psi, 3000 psi, 5000 psi, 10000 psi, etc.). This back pressure for injection of the encapsulating material can result in large differential pressures (e.g., 10 psi, 20 psi, 25 psi, 30 psi, 50 psi, 60 psi, 75 psi, 80 psi, 90 psi, 100 psi, 125 psi, 150 psi, 200 psi, 250 psi, 300 psi, 500 psi, values or ranges therebetween, etc.) that can further result in deformation of the electrode stack and/or battery cell. The use of a gel electrolyte (e.g., as discussed above) can provide a technical advantage over a liquid electrolyte by hindering (e.g., resisting, preventing, etc.) this deformation during the encapsulation process (as shown for example by comparing FIG. 11A showing an example battery cell with a gel-electrolyte with the example battery of FIG. 11B that includes a liquid electrolyte).

Examples of injected materials (and/or resulting encapsulating materials) can include: metals and/or alloys (particularly but not exclusively those with lower melting point such as a melting point below about 250° C. such as fusible alloys), glass, ceramics, cermets, elastomers, thermoplastics (e.g., acrylics; acrylonitrile butadiene styrene; polyamides; polylactic acid; polybenzimidazole; polycarbonate; polyether sulfone; polyoxymethylene; polyether ether ketone; polyetherimide; polyethylene; polyphenylene oxide; polyphenylene sulfide; polypropylene; polystyrene; polyvinyl chloride; polyvinylidene fluoride; polytetrafluoroethylene; composites with carbon, glass, aramid, etc.; combinations thereof; etc.), thermosets (e.g., epoxy, polyimides, bismaleimides, cyanate esters, polycyanurates, polyester, polyurethane, polyurea, polyurea/polyurethane hybrids, bakelite, duroplast, benzoxazines, furan, silicone, thiolyte, vinyl esters, combinations thereof, etc.), composited and/or combinations thereof, and/or other such materials.

However, additionally or alternatively, fusible core injection moulding (e.g., where the electrode stack and/or battery cell can be inserted into the internal cavities separate from the moulding process), extrusion, blow moulding, film blowing, thermoforming, compression moulding, transfer moulding, pultrusion, welding, brazing, filament winding, solvent bonding, vacuum forming, rotational moulding, and/or other suitable process can be used to form the encapsulating material (either directly around the electrode stack and/or battery cell or with a cavity that can enable the electrode stack or battery cell to be inserted therein). However, the encapsulating material can otherwise be formed. In some variants, the encapsulating material can form a hermetic seal around the electrode stack and/or battery cell. In other variants, the encapsulating material may not fully isolate the electrode stack and/or battery cell from an external environment (e.g., where a pouch or housing of the battery cell may provide such a property).

In some variants, S600 can further include one or more additional processing steps (e.g., curing such as thermal, optical, UV, chemical such as using solvents, electromagnetic, x-ray, etc.; finishing such as calendaring, polishing, etc.; dyeing; etc.) can be performed on the encapsulated material (e.g., to improve mechanical properties, to impart desired characteristics, to improve adhesion between the electrode stack and/or battery cell, etc.).

Alternative embodiments implement the above methods and/or processing modules in non-transitory computer-readable media, storing computer-readable instructions that, when executed by a processing system, cause the processing system to perform the method(s) discussed herein (e.g., by providing automated instructions for robotic or other manufacturing systems to perform the steps of the method). The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, and/or FPGA/ASIC. However, the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the preceding system and/or method can be used with, in addition to, in lieu of, or otherwise integrated with all or a portion of the systems and/or methods disclosed in the applications mentioned above, each of which are incorporated in their entirety by this reference.

As used herein, “substantially” or other words of approximation (e.g., “about,” “approximately,” etc.) can be within a predetermined error threshold or tolerance of a metric, component, or other reference (e.g., within 0.001%, 0.01%, 0.1%, 1%, 5%, 10%, 20%, 30% of a reference), or be otherwise interpreted.

As a person skilled in the art will recognize from the previous detailed description and from the figures and claims, modifications and changes can be made to the preferred embodiments of the invention without departing from the scope of this invention defined in the following claims.

### SPECIFIC EXAMPLES

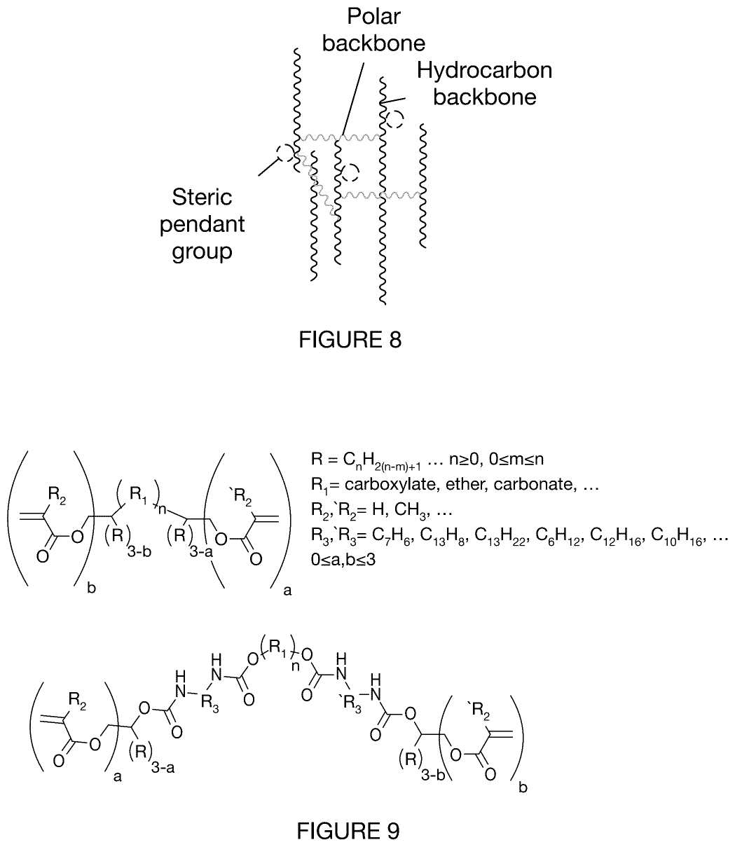

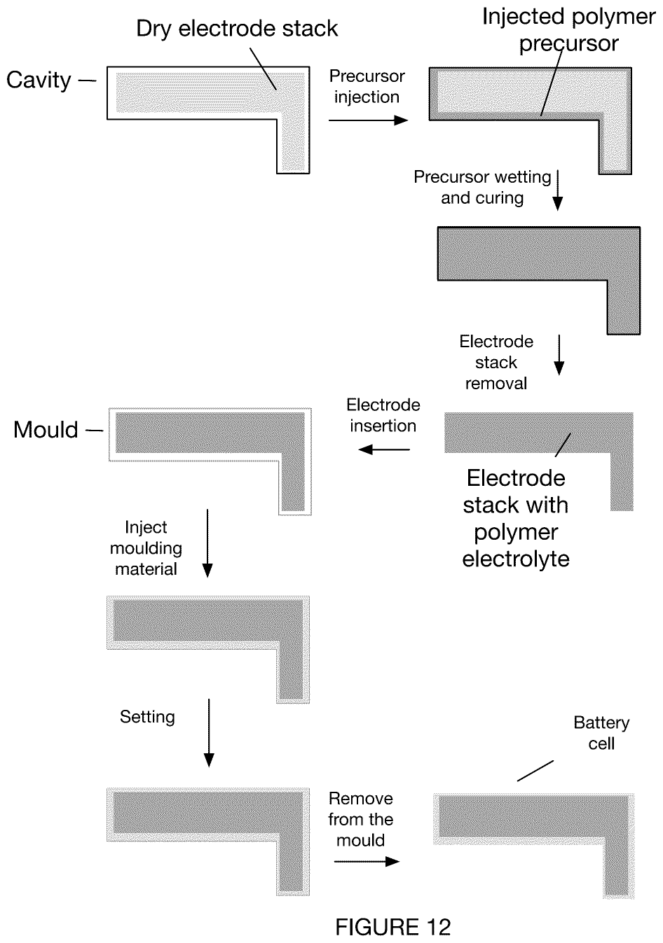

A numbered list of specific examples of the technology described herein are provided below. A person of skill in the art will recognize that the scope of the technology is not limited to and/or by these specific examples.
1. A battery cell comprising one or more cathode each comprising: a cathode substrate; cathode active material deposited on the cathode substrate; a first conductive additive, intermixed with the cathode active material; and a first binder intermixed with the cathode active material and the first conductive additive, one or more anode each comprising: an anode substrate; anode active material deposited on the anode substrate: a second conductive additive, intermixed with the anode active material; and a second binder intermixed with the anode active material and the second conductive additive, one or more separator disposed between each cathode and anode pair, wherein electrochemically active ions are transportable through the separator, wherein the separator is electrically insulating, a gel polymer electrolyte comprising: a solvent selected from the group consisting of: ethylene carbonate, fluoroethylene carbonate, propylene carbonate, vinylene carbonate, trimethylene carbonate, 1,2-butylene carbonate, 2,3-butylene carbonate, trifluoropropylene carbonate, methylene ethylene carbonate, dioxazolone, hexahydroxybenzene triscarbonate, ethylenetetracarboxylic dianhydride, tetrahydroxy-1,4-benzoquinone biscarbonate, di-tert-butyl carbonate, di-tert-butyl dicarbonate, diethyl carbonate, diethyl pyrocarbonate, dimethyl carbonate, ethyl methyl carbonate, diallyl carbonate, diphenyl carbonate, methyl (2,2,2-trifluoroethyl) carbonate, bis(2,2,2-trifluoroethyl) carbonate, dimethoxyethane, diethyl ether, tetrahydrofuran (oxolane), tetraethoxymethane, tetramethoxymethane, triethyl orthoacetate, triethyl orthoformate, trimethylorthoformate, 2,2-diethoxytetrahydrofuran, methyl formate, ethyl formate, methyl propionate, methyl butanoate, ethyl formate, ethyl acetate, ethyl propionate, propyl formate, propyl acetate, propyl proprionate, and combinations thereof; a salt selected from the group consisting of: lithium hexafluorophosphate, lithium hexafluoroarsenate, lithium tetrafluoroborate, lithium chlorate, lithium 2,3,7,8-tetraoxo-1,4,6,9-tetraoxa-5-boraspiro[4.4]nonan-5-uide, lithium difluorophosphate, lithium bis(fluorosulfonyl)imide, lithium bis(trifluoromethanesulfonyl)imide, lithium-cyclo-difluoromethane-1,1-bis(sulfonyl)imide, lithium fluoromalonato (difluoro) borate, lithium trifluoromethanesulfonate, lithium tetraoxo-1,4,6,9-tetraoxa-5-boraspiro[4,4]nonan-5-uide, lithium trifluoro[(trifluoromethansulfonylazanidyl) sulfonyl]methane, lithium nitrate, lithium 2,2-difluoro-4,5-dioxo-1,3,2-dioxaborolane-2-uide, and combinations thereof; an additive selected from the group consisting of: trivinylcyclotriboroxane, VC, LiDFOB, LiBOB, sulfone, ethyl methyl sulfone, tetramethyl sulfone, prop-1-ene-1,3-sulfone, 1,3-propane sultone, cyclic sulfate, lactic acid O-carboxyanhydride, dioxolone, 5-methyl-4-((trifluoromethoxy)methyl)-1,3-dioxol-2-one, phenyl boronic acid glycol ester, 5-methyl-4-((trimethylsilyloxy)methyl)-1,3-dioxol-2-one, trimethylphosphate, triethylphosphate, tributylphosphate, triphenylphosphate, tris(2,2,2-trifluoroethyl)phosphate, methyl P,P-bis(2,2,2-trifluoroethyl)phosphate, trimethylphosphite, tris(2,2,2-trifluoroethyl)phosphite, dimethyl methyl phosphate, diethyl ethylphosphate, bis(2,2,2-trifluoroethyl)methylphosphate, bis(2,2,2-trifluoroethyl)ethylphosphate, hexa(methoxy)cyclotriphosphazene, (ethoxy) pentafluorocyclotriphosphazene, (phenoxy) pentafluorocyclotriphosphazene, and combinations thereof; and a cross-linked polymer network (as shown for example in FIG. 8) comprising a plurality of hydrocarbon backbones crosslinked by crosslinking regions comprising polar bonding domains (e.g., hydrogen bond donors and/or acceptors, ionic chelators, ion pairing, dynamic covalent bonds, n-n interactions, n-cation interactions, n-anion interactions, polarizable bonds, etc.), an overmoulded housing surrounding the cathode, the anode, the separator, and the gel polymer electrolyte; wherein the battery cell comprises a non-zero (inclusive of infinite) radius of curvature in at least 2 orthogonal axes.
2. The battery cell of Illustrative example 1, further comprising a pouch surrounding the cathode, the anode, the separator, and the gel polymer electrolyte, wherein the overmoulded housing surrounds the pouch.
3. The battery cell of Illustrative example 2, wherein the overmoulded housing is chemically (e.g., via chemical bonds) or physically (e.g,. forming interlinking structures) bonded to the pouch.
4. The battery cell of Illustrative example 1, wherein the overmoulded housing is chemically bonded to the gel polymer electrolyte.
5. The battery cell of any of Illustrative examples 1-4, wherein the cross-linked polymer network is formed from (e.g., by curing, by polymerizing, etc.) monomers selected from the group consisting of: polycarbonate diureido diacrylate, polyether diureido diacrylate, polyester diureido diacrylate, polycarbonate polyether diureido diacrylate, polycarbonate polyester diureido diacrylate, polyether polyester diureido diacrylate, polycarbonate polyether polyester diureido diacrylate, polyether polyester diureido dimethacrylate, polycarbonate polyether polyester diureido dimethacrylate, polycarbonate diureido dimethacrylate, polyether diureido dimethacrylate, polyester diureido dimethacrylate, polycarbonate polyether diureido dimethacrylate, polycarbonate polyester diureido dimethacrylate, polycarbonate triureido triacrylate, polyether triureido triacrylate, polyester triureido triacrylate, polycarbonate polyether triureido triacrylate, polycarbonate polyester triureido triacrylate, polyether polyester triureido triacrylate, polycarbonate polyether polyester triureido triacrylate, polycarbonate triureido trimethacrylate, polyether triureido trimethacrylate, polyester triureido trimethacrylate, polycarbonate polyether triureido trimethacrylate, polycarbonate polyester triureido trimethacrylate, polyether polyester triureido trimethacrylate, polycarbonate polyether polyester triureido trimethacrylate,polycarbonate tetraaureido tetracrylate, polyether tetraaureido tetracrylate, polyester tetraaureido tetracrylate, polycarbonate polyether tetraaureido tetracrylate, polycarbonate polyester tetraaureido tetracrylate, polyether polyester tetraaureido tetracrylate, polycarbonate polyether polyester tetraaureido tetracrylate, polyether polyester tetraureido tetramethacrylate, polycarbonate polyether polyester tetraureido tetramethacrylate, polycarbonate tetraureido tetramethacrylate, polyether tetraureido tetramethacrylate, polyester tetraureido tetramethacrylate, polycarbonate polyether tetraureido tetramethacrylate, polycarbonate polyester tetraureido tetramethacrylate, polycarbonate hexaaureido hexacrylate, polyether hexaaureido hexacrylate, polyester hexaaureido hexacrylate, polycarbonate polyether hexaaureido hexacrylate, polycarbonate polyester hexaaureido hexacrylate, polyether polyester hexaaureido hexacrylate, polycarbonate polyether polyester hexaaureido hexacrylate, polyether polyester hexaureido hexamethacrylate, polycarbonate polyether polyester hexaureido hexamethacrylate, polycarbonate hexaureido hexamethacrylate, polyether hexaureido hexamethacrylate, polyester hexaureido hexamethacrylate, polycarbonate polyether hexaureido hexamethacrylate, polycarbonate polyester hexaureido hexamethacrylate, polycarbonate diacrylate, polyether diacrylate, polyester diacrylate, polycarbonate polyether diacrylate, polycarbonate polyester diacrylate, polyether polyester diacrylate, polycarbonate polyether polyester diacrylate, polycarbonate dimethacrylate, polyether dimethacrylate, polyester dimethacrylate, polycarbonate polyether dimethacrylate, polycarbonate polyester dimethacrylate, polyether polyester dimethacrylate, polycarbonate polyether polyester dimethacrylate, polycarbonate triacrylate, polyether triacrylate, polyester triacrylate, polycarbonate polyether triacrylate, polycarbonate polyester triacrylate, polyether polyester triacrylate, polycarbonate polyether polyester triacrylate, polycarbonate trimethacrylate, polyether trimethacrylate, polyester trimethacrylate, polycarbonate polyether trimethacrylate, polycarbonate polyester trimethacrylate, polyether polyester trimethacrylate, polycarbonate polyether polyester trimethacrylate, polycarbonate tetraacrylate, polyether tetraacrylate, polyester tetraacrylate, polycarbonate polyether tetraacrylate, polycarbonate polyester tetraacrylate, polyether polyester tetraacrylate, polycarbonate polyether polyester tetraacrylate, polycarbonate tetramethacrylate, polyether tetramethacrylate, polyester tetramethacrylate, polycarbonate polyether tetramethacrylate, polycarbonate polyester tetramethacrylate, polyether polyester tetramethacrylate, polycarbonate polyether polyester tetramethacrylate, polycarbonate hexacrylate, polyether hexacrylate, polyester hexacrylate, polycarbonate polyether hexacrylate, polycarbonate polyester hexacrylate, polyether polyester hexacrylate, polycarbonate polyether polyester hexacrylate, polycarbonate hexamethacrylate, polyether hexamethacrylate, polyester hexamethacrylate, polycarbonate polyether hexamethacrylate, polycarbonate polyester hexamethacrylate, polyether polyester hexamethacrylate, polycarbonate polyether polyester hexamethacrylate, trimethylolpropane ethoxylate triacrylate, trimethylolpropane triacrylate, trimethylolpropane propoxylate triacrylate, glycerol propoxylate triacrylate, pentaerythritol triacrylate, zirconium bromonorbornanelactone carboxylate triacrylate, trimethylolpropane ethoxylate trimethacrylate, trimethylolpropane trimethacrylate, trimethylolpropane propoxylate trimethacrylate, glycerol propoxylate trimethacrylate, pentaerythritol trimethacrylate, zirconium bromonorbornanelactone carboxylate trimethacrylate, pentaerythritol tetraacrylate, 3-(N,N,N,N tetrakis(propionate) hexanediamino)-2-hydroxypropyl acrylate, pentaerythritol tetramethacrylate, 3-(N,N,N,N tetrakis(propionate) hexanediamino)-2-hydroxypropyl methacrylate, dipentaerythritol pentaacrylate, dipentaerythritol pentaacrylate, dipentaerythritol hexaacrylate, dipentaerythritol hexamethacrylate, isobornyl acrylate, hexadecyl acrylate, t-butyl acrylate, silsesquioxane acrylates, methacrylic acid, methyl methacrylate, benzyl methacrylate, ethyl methacrylate, isopropyl methacrylate, hydropropyl methacrylate, isobutyl methacrylate, t-butyl methacrylate, cyclohexyl methacrylate, isobornyl methacrylate, phenyl methacrylate, trimethylsilyl methacrylate, T6 silsesquioxane methacrylate, T8 silsesquioxane methacrylate, T10 silsesquioxane methacrylate, T12 silsesquioxane methacrylate, methyl cyanoacrylate, ethyl cyanoacrylate, propyl cyanoacrylate, isopropyl cyanoacrylate, butyl cyanoacrylate, allyl cyanoacrylate, methoxyethyl cyanoacrylate, T6 silsesquioxane cyanoacrylate, T8 silsesquioxane cyanoacrylate, T10 silsesquioxane cyanoacrylate, T12 silsesquioxane cyanoacrylate, acrylamide, N,N dimethyl acrylamide, t-butyl acrylamide, styrene, methylstyrene, dimethylstyrene, trimethylstyrene, t-butyl styrene, ethoxystyrene, acetoxystyrene, methacrylonitrile, and combinations thereof.
6. The battery cell of any of Illustrative examples 1-5, wherein the overmoulded housing is at most 100 mm larger than the cathode, the anode, the separator, and the gel polymer electrolyte.
7. The battery cell of Illustrative 6, wherein the overmoulded housing is at most 0.5 mm larger than the cathode, the anode, the separator, and the gel polymer electrolyte.
8. The battery cell of any of Illustrative examples 1-7, wherein the cathode, the separator, and the anode are terraced.
9. The battery cell of any of Illustrative examples 1-8, wherein a hydrocarbon backbone of the plurality of hydrocarbon backbones further comprises sterically hindered pendant groups.
10. A method (as shown for example in FIG. 12) comprising: injecting a prepolymer electrolyte into a cavity (e.g., a pouch) surrounding a dry battery electrode stack; wetting the dry battery electrode stack with the prepolymer electrolyte to form a wetted battery electrode stack; iteratively (one or more times), until a target morphology is achieved: bending the the wetted battery electrode stack and the prepolymer electrolyte (and optionally the pouch); and releasing strain within the wetted battery electrode stack and the prepolymer electrolyte (and optionally the pouch) resulting from the bending; and curing the prepolymer electrolyte to form a cured gel electrolyte while the wetted battery electrode stack and the prepolymer electrolyte (and optionally the pouch) are retained in the target morphology, wherein the cured gel electrolyte preserves the target morphology of the wetted battery electrode stack (or full battery cell) by sustaining a target tensile stress, target compressive stress, and/or target shear stress of the wetted electrode stack.
11. The method of Illustrative example 10, further comprising, after curing the prepolymer electrolyte injection moulding a housing around the cured gel electrolyte and the wetted battery electrode stack.
12. The method of Illustrative example 11, further comprising removing the cured gel electrolyte and the wetted battery electrode stack from the cavity (e.g,. pouch) prior to injection moulding the housing.
13. The method of any of Illustrative example 11-12, wherein the cured gel electrolyte and the wetted battery electrode are at most about 2 mm from an outer surface of the housing.
14. The method of any of Illustrative example 11-13, wherein during the injection moulding an injection pressure is greater than 50 psi (e.g., 100 psi, 200 psi, 250 psi, 500 psi, 750 psi, 1000 psi, 1200 psi, 1500 psi, 2000 psi, 2500 psi, 5000 psi, etc.), wherein the cured gel electrolyte and the wetted battery electrode stack do not undergo substantially any relative movement during the injection moulding (e.g., undergo a relative translation between adjacent layers less than about 1 mm).
15. The method of any of Illustrative example 11-14, wherein the injection moulding is performed at a temperature between about 100 and 350° C., wherein the cured gel electrolyte and the wetted battery electrode stack do not substantially degrade after the injection moulding process.
16. The method of any of Illustrative example 10-15, wherein the dry battery electrode stack is terraced.
17. The method of any of Illustrative example 10-15, wherein the prepolymer electrolyte comprises: a solvent selected from the group consisting of: ethylene carbonate, fluoroethylene carbonate, propylene carbonate, vinylene carbonate, trimethylene carbonate, 1,2-butylene carbonate, 2,3-butylene carbonate, trifluoropropylene carbonate, methylene ethylene carbonate, dioxazolone, hexahydroxybenzene triscarbonate, ethylenetetracarboxylic dianhydride, tetrahydroxy-1,4-benzoquinone biscarbonate, di-tert-butyl carbonate, di-tert-butyl dicarbonate, diethyl carbonate, diethyl pyrocarbonate, dimethyl carbonate, ethyl methyl carbonate, diallyl carbonate, diphenyl carbonate, methyl (2,2,2-trifluoroethyl) carbonate, bis(2,2,2-trifluoroethyl) carbonate, dimethoxyethane, diethyl ether, tetrahydrofuran (oxolane), tetraethoxymethane, tetramethoxymethane, triethyl orthoacetate, triethyl orthoformate, trimethylorthoformate, 2,2-diethoxytetrahydrofuran, methyl formate, ethyl formate, methyl propionate, methyl butanoate, ethyl formate, ethyl acetate, ethyl propionate, propyl formate, propyl acetate, propyl proprionate, and combinations thereof; a salt selected from the group consisting of: lithium hexafluorophosphate, lithium hexafluoroarsenate, lithium tetrafluoroborate, lithium chlorate, lithium 2,3,7,8-tetraoxo-1,4,6,9-tetraoxa-5-boraspiro[4.4]nonan-5-uide, lithium difluorophosphate, lithium bis(fluorosulfonyl)imide, lithium bis(trifluoromethanesulfonyl)imide, lithium-cyclo-difluoromethane-1,1-bis(sulfonyl)imide, lithium fluoromalonato (difluoro) borate, lithium trifluoromethanesulfonate, lithium tetraoxo-1,4,6,9-tetraoxa-5-boraspiro[4,4]nonan-5-uide, lithium trifluoro[(trifluoromethansulfonylazanidyl) sulfonyl]methane, lithium nitrate, lithium 2,2-difluoro-4,5-dioxo-1,3,2-dioxaborolane-2-uide, and combinations thereof; an additive selected from the group consisting of: trivinylcyclotriboroxane, VC, LiDFOB, LiBOB, sulfone, ethyl methyl sulfone, tetramethyl sulfone, prop-1-ene-1,3-sulfone, 1,3-propane sultone, cyclic sulfate, lactic acid O-carboxyanhydride, dioxolone, 5-methyl-4-((trifluoromethoxy)methyl)-1,3-dioxol-2-one, phenyl boronic acid glycol ester, 5-methyl-4-((trimethylsilyloxy)methyl)-1,3-dioxol-2-one, trimethylphosphate, triethylphosphate, tributylphosphate, triphenylphosphate, tris(2,2,2-trifluoroethyl)phosphate, methyl P,P-bis(2,2,2-trifluoroethyl)phosphate, trimethylphosphite, tris(2,2,2-trifluoroethyl)phosphite, dimethyl methyl phosphate, diethyl ethylphosphate, bis(2,2,2-trifluoroethyl)methylphosphate, bis(2,2,2-trifluoroethyl)ethylphosphate, hexa(methoxy)cyclotriphosphazene, (ethoxy) pentafluorocyclotriphosphazene, (phenoxy) pentafluorocyclotriphosphazene, and combinations thereof;and a monomer selected from the group consisting of: polycarbonate diureido diacrylate, polyether diureido diacrylate, polyester diureido diacrylate, polycarbonate polyether diureido diacrylate, polycarbonate polyester diureido diacrylate, polyether polyester diureido diacrylate, polycarbonate polyether polyester diureido diacrylate, polyether polyester diureido dimethacrylate, polycarbonate polyether polyester diureido dimethacrylate, polycarbonate diureido dimethacrylate, polyether diureido dimethacrylate, polyester diureido dimethacrylate, polycarbonate polyether diureido dimethacrylate, polycarbonate polyester diureido dimethacrylate, polycarbonate triureido triacrylate, polyether triureido triacrylate, polyester triureido triacrylate, polycarbonate polyether triureido triacrylate, polycarbonate polyester triureido triacrylate, polyether polyester triureido triacrylate, polycarbonate polyether polyester triureido triacrylate, polycarbonate triureido trimethacrylate, polyether triureido trimethacrylate, polyester triureido trimethacrylate, polycarbonate polyether triureido trimethacrylate, polycarbonate polyester triureido trimethacrylate, polyether polyester triureido trimethacrylate, polycarbonate polyether polyester triureido trimethacrylate, polycarbonate tetraaureido tetracrylate, polyether tetraaureido tetracrylate, polyester tetraaureido tetracrylate, polycarbonate polyether tetraaureido tetracrylate, polycarbonate polyester tetraaureido tetracrylate, polyether polyester tetraaureido tetracrylate, polycarbonate polyether polyester tetraaureido tetracrylate, polyether polyester tetraureido tetramethacrylate, polycarbonate polyether polyester tetraureido tetramethacrylate, polycarbonate tetraureido tetramethacrylate, polyether tetraureido tetramethacrylate, polyester tetraureido tetramethacrylate, polycarbonate polyether tetraureido tetramethacrylate, polycarbonate polyester tetraureido tetramethacrylate, polycarbonate hexaaureido hexacrylate, polyether hexaaureido hexacrylate, polyester hexaaureido hexacrylate, polycarbonate polyether hexaaureido hexacrylate, polycarbonate polyester hexaaureido hexacrylate, polyether polyester hexaaureido hexacrylate, polycarbonate polyether polyester hexaaureido hexacrylate, polyether polyester hexaureido hexamethacrylate, polycarbonate polyether polyester hexaureido hexamethacrylate, polycarbonate hexaureido hexamethacrylate, polyether hexaureido hexamethacrylate, polyester hexaureido hexamethacrylate, polycarbonate polyether hexaureido hexamethacrylate, polycarbonate polyester hexaureido hexamethacrylate, polycarbonate diacrylate, polyether diacrylate, polyester diacrylate, polycarbonate polyether diacrylate, polycarbonate polyester diacrylate, polyether polyester diacrylate, polycarbonate polyether polyester diacrylate, polycarbonate dimethacrylate, polyether dimethacrylate, polyester dimethacrylate, polycarbonate polyether dimethacrylate, polycarbonate polyester dimethacrylate, polyether polyester dimethacrylate, polycarbonate polyether polyester dimethacrylate, polycarbonate triacrylate, polyether triacrylate, polyester triacrylate, polycarbonate polyether triacrylate, polycarbonate polyester triacrylate, polyether polyester triacrylate, polycarbonate polyether polyester triacrylate, polycarbonate trimethacrylate, polyether trimethacrylate, polyester trimethacrylate, polycarbonate polyether trimethacrylate, polycarbonate polyester trimethacrylate, polyether polyester trimethacrylate, polycarbonate polyether polyester trimethacrylate, polycarbonate tetraacrylate, polyether tetraacrylate, polyester tetraacrylate, polycarbonate polyether tetraacrylate, polycarbonate polyester tetraacrylate, polyether polyester tetraacrylate, polycarbonate polyether polyester tetraacrylate, polycarbonate tetramethacrylate, polyether tetramethacrylate, polyester tetramethacrylate, polycarbonate polyether tetramethacrylate, polycarbonate polyester tetramethacrylate, polyether polyester tetramethacrylate, polycarbonate polyether polyester tetramethacrylate, polycarbonate hexacrylate, polyether hexacrylate, polyester hexacrylate, polycarbonate polyether hexacrylate, polycarbonate polyester hexacrylate, polyether polyester hexacrylate, polycarbonate polyether polyester hexacrylate, polycarbonate hexamethacrylate, polyether hexamethacrylate, polyester hexamethacrylate, polycarbonate polyether hexamethacrylate, polycarbonate polyester hexamethacrylate, polyether polyester hexamethacrylate, polycarbonate polyether polyester hexamethacrylate, trimethylolpropane ethoxylate triacrylate, trimethylolpropane triacrylate, trimethylolpropane propoxylate triacrylate, glycerol propoxylate triacrylate, pentaerythritol triacrylate, zirconium bromonorbornanelactone carboxylate triacrylate, trimethylolpropane ethoxylate trimethacrylate, trimethylolpropane trimethacrylate, trimethylolpropane propoxylate trimethacrylate, glycerol propoxylate trimethacrylate, pentaerythritol trimethacrylate, zirconium bromonorbornanelactone carboxylate trimethacrylate, pentaerythritol tetraacrylate, 3-(N,N,N,N tetrakis(propionate) hexanediamino)-2-hydroxypropyl acrylate, pentaerythritol tetramethacrylate, 3-(N,N,N,N tetrakis(propionate) hexanediamino)-2-hydroxypropyl methacrylate, dipentaerythritol pentaacrylate, dipentaerythritol pentaacrylate, dipentaerythritol hexaacrylate, dipentaerythritol hexamethacrylate, and combinations thereof.
18. The method of Illustrative example 17, wherein the prepolymer electrolyte further comprising: an inhibitor selected from the group consisting of phenothiazine, butylated hydroxytoluene, hydroquinones, 4-methoxyphenol, monobenzone, hydroquinone, guaiacol, 2-hydroxy-5-methoxybenzaldehyde, 1,2-benzoquinone, 1,4-benzoquinone, 1,4-naphthoquinone, 9,10-anthraquinone, chloranil, quinone methide, p-phenylenediamines, diethylhydroxylamine, hydroxylhydroxylamine, (2,2,6,6-Tetramethylpiperidin-1-yl)oxyl (TEMPO), 4-hydroxy-TEMPO, and combinations thereof; and an initiator selected from the group consisting of: 1-1′-azobis(cyclohexanecarbonitrile), 2,2′-azobisisobutyronitrile, 2,2-Bis(tert-butylperoxy) butane, 1,1-bis(tert-butylperoxy)cyclohexane, 2,2′-azobis[2-(2-imidazolin-2-yl)-propane]dihydrochloride, 2,5-bis(tert-butylperoxy)-2,5-dimethylhexane, 2,5-bis(tert-butylperoxy)-2,5-dimethyl-3-hexyne, bis(1-(tertbutylperoxy)-1-methylethyl)benzene, 1,1-bis(tert-butylperoxy)-3,3,5-trimethylcyclohexane, tert-butyl peracetate, tert-butyl hydroperoxide, cumene hydroperoxide, di-tert-butyl peroxide, tert-butyl peroxybenzoate, tert-butylperoxyisopropyl carbonate, dicumyl peroxide, benzoyl peroxide, lauroyl peroxide, 2,4-pentanedione peroxide, peracetic acid, tert-amyl peroxybenzoate, 4,4-azobis(4-cyanovaleric acid), 1,1′-azobis(cyclohexanecarbonitrile), ammonium persulfate, potassium persulfate (or other persulfate salts), lauroyl peroxide, tert-butyl peroxide, tert-butyl peroxybenzoate, benzoyl peroxide, phenylbis(2,4,6-trimethylbenzoyl) phosphine oxide), 2,2-dimethoxy-2-phenylacetophenone, and combinations thereof.
19. The method of any of Illustrative example 17-18, wherein the prepolymer electrolyte comprises about 0-80% by mass of the solvent, about 5-20% by mass of the salt, about 0.01-10% by mass of the additive, about 10-80% by mass of the monomer, about 0-5% by mass of the inhibitor, about 0.001-5% by mass of the initiator, wherein the total percentage adds up to 100%.
20. The method of any of Illustrative example 10-19, wherein curing the prepolymer electrolyte comprises thermally treating the prepolymer electrolyte to initiate a polymerization reaction.
21. A method of producing the battery cell of any of Illustrative examples 1-9.
22. A battery formed by the method of any of Illustrative examples 10-21.

We claim:

1. A battery cell comprising:
a cathode comprising:
a cathode substrate;
cathode active material deposited on the cathode substrate:
a first conductive additive, intermixed with the cathode active material; and
a first binder intermixed with the cathode active material and the first conductive additive;
an anode comprising:
an anode substrate;
anode active material deposited on the anode substrate:
a second conductive additive, intermixed with the anode active material; and
a second binder intermixed with the anode active material and the second conductive additive;
a separator disposed between the cathode and the anode, wherein electrochemically active ions are transportable through the separator, wherein the separator is electrically insulating;
a gel polymer electrolyte comprising:
a solvent selected from the group consisting of: ethylene carbonate, fluoroethylene carbonate, propylene carbonate, vinylene carbonate, trimethylene carbonate, 1,2-butylene carbonate, 2,3-butylene carbonate, trifluoropropylene carbonate, methylene ethylene carbonate, dioxazolone, hexahydroxybenzene triscarbonate, ethylenetetracarboxylic dianhydride, tetrahydroxy-1,4-benzoquinone biscarbonate, di-tert-butyl carbonate, di-tert-butyl dicarbonate, diethyl carbonate, diethyl pyrocarbonate, dimethyl carbonate, ethyl methyl carbonate, diallyl carbonate, diphenyl carbonate, methyl (2,2,2-trifluoroethyl) carbonate, bis(2,2,2-trifluoroethyl) carbonate, dimethoxyethane, diethyl ether, tetrahydrofuran (oxolane), tetraethoxymethane, tetramethoxymethane, triethyl orthoacetate, triethyl orthoformate, trimethylorthoformate, 2,2-diethoxytetrahydrofuran, methyl formate, ethyl formate, methyl propionate, methyl butanoate, ethyl formate, ethyl acetate, ethyl propionate, propyl formate, propyl acetate, propyl proprionate, and combinations thereof;
a salt selected from the group consisting of: lithium hexafluorophosphate, lithium hexafluoroarsenate, lithium tetrafluoroborate, lithium chlorate, lithium 2,3,7,8-tetraoxo-1,4,6,9-tetraoxa-5-boraspiro[4.4]nonan-5-uide, lithium difluorophosphate, lithium bis(fluorosulfonyl)imide, lithium bis(trifluoromethanesulfonyl)imide, lithium-cyclo-difluoromethane-1,1-bis(sulfonyl)imide, lithium fluoromalonato (difluoro) borate, lithium trifluoromethanesulfonate, lithium tetraoxo-1,4,6,9-tetraoxa-5-boraspiro[4,4]nonan-5-uide, lithium trifluoro[(trifluoromethansulfonylazanidyl)sulfonyl]methane, lithium nitrate, lithium 2,2-difluoro-4,5-dioxo-1,3,2-dioxaborolane-2-uide, and combinations thereof;
an additive selected from the group consisting of: trivinylcyclotriboroxane, VC, LiDFOB, LiBOB, sulfone, ethyl methyl sulfone, tetramethyl sulfone, prop-1-ene-1,3-sulfone, 1,3-propane sultone, cyclic sulfate, lactic acid O-carboxyanhydride, dioxolone, 5-methyl-4-((trifluoromethoxy)methyl)-1,3-dioxol-2-one, phenyl boronic acid glycol ester, 5-methyl-4-((trimethylsilyloxy)methyl)-1,3-dioxol-2-one, trimethylphosphate, triethylphosphate, tributylphosphate, triphenylphosphate, tris(2,2,2-trifluoroethyl)phosphate, methyl P,P-bis(2,2,2-trifluoroethyl)phosphate, trimethylphosphite, tris(2,2,2-trifluoroethyl)phosphite, dimethyl methyl phosphate, diethyl ethylphosphate, bis(2,2,2-trifluoroethyl)methylphosphate, bis(2,2,2-trifluoroethyl)ethylphosphate, hexa(methoxy)cyclotriphosphazene, (ethoxy)pentafluorocyclotriphosphazene, (phenoxy)pentafluorocyclotriphosphazene, and combinations thereof; and
a cross-linked polymer network comprising a plurality of hydrocarbon backbones crosslinked by crosslinking regions comprising hydrogen bonding domains;
an overmoulded housing surrounding the cathode, the anode, the separator, and the gel polymer electrolyte.

2. The battery cell of claim 1, further comprising a pouch surrounding the cathode, the anode, the separator, and the gel polymer electrolyte, wherein the overmoulded housing surrounds the pouch.

3. The battery cell of claim 2, wherein the overmoulded housing is chemically or physically bonded to the pouch.

4. The battery cell of claim 1, wherein the overmoulded housing is chemically bonded to the gel polymer electrolyte.

5. The battery cell of claim 1, wherein the cross-linked polymer network is formed from monomers selected from the group consisting of: polycarbonate diureido diacrylate, polyether diureido diacrylate, polyester diureido diacrylate, polycarbonate polyether diureido diacrylate, polycarbonate polyester diureido diacrylate, polyether polyester diureido diacrylate, polycarbonate polyether polyester diureido diacrylate, polyether polyester diureido dimethacrylate, polycarbonate polyether polyester diureido dimethacrylate, polycarbonate diureido dimethacrylate, polyether diureido dimethacrylate, polyester diureido dimethacrylate, polycarbonate polyether diureido dimethacrylate, polycarbonate polyester diureido dimethacrylate, polycarbonate triureido triacrylate, polyether triureido triacrylate, polyester triureido triacrylate, polycarbonate polyether triureido triacrylate, polycarbonate polyester triureido triacrylate, polyether polyester triureido triacrylate, polycarbonate polyether polyester triureido triacrylate, polycarbonate triureido trimethacrylate, polyether triureido trimethacrylate, polyester triureido trimethacrylate, polycarbonate polyether triureido trimethacrylate, polycarbonate polyester triureido trimethacrylate, polyether polyester triureido trimethacrylate, polycarbonate polyether polyester triureido trimethacrylate, polycarbonate tetraaureido tetracrylate, polyether tetraaureido tetracrylate, polyester tetraaureido tetracrylate, polycarbonate polyether tetraaureido tetracrylate, polycarbonate polyester tetraaureido tetracrylate, polyether polyester tetraaureido tetracrylate, polycarbonate polyether polyester tetraaureido tetracrylate, polyether polyester tetraureido tetramethacrylate, polycarbonate polyether polyester tetraureido tetramethacrylate, polycarbonate tetraureido tetramethacrylate, polyether tetraureido tetramethacrylate, polyester tetraureido tetramethacrylate, polycarbonate polyether tetraureido tetramethacrylate, polycarbonate polyester tetraureido tetramethacrylate, polycarbonate hexaaureido hexacrylate, polyether hexaaureido hexacrylate, polyester hexaaureido hexacrylate, polycarbonate polyether hexaaureido hexacrylate, polycarbonate polyester hexaaureido hexacrylate, polyether polyester hexaaureido hexacrylate, polycarbonate polyether polyester hexaaureido hexacrylate, polyether polyester hexaureido hexamethacrylate, polycarbonate polyether polyester hexaureido hexamethacrylate, polycarbonate hexaureido hexamethacrylate, polyether hexaureido hexamethacrylate, polyester hexaureido hexamethacrylate, polycarbonate polyether hexaureido hexamethacrylate, polycarbonate polyester hexaureido hexamethacrylate, polycarbonate diacrylate, polyether diacrylate, polyester diacrylate, polycarbonate polyether diacrylate, polycarbonate polyester diacrylate, polyether polyester diacrylate, polycarbonate polyether polyester diacrylate, polycarbonate dimethacrylate, polyether dimethacrylate, polyester dimethacrylate, polycarbonate polyether dimethacrylate, polycarbonate polyester dimethacrylate, polyether polyester dimethacrylate, polycarbonate polyether polyester dimethacrylate, polycarbonate triacrylate, polyether triacrylate, polyester triacrylate, polycarbonate polyether triacrylate, polycarbonate polyester triacrylate, polyether polyester triacrylate, polycarbonate polyether polyester triacrylate, polycarbonate trimethacrylate, polyether trimethacrylate, polyester trimethacrylate, polycarbonate polyether trimethacrylate, polycarbonate polyester trimethacrylate, polyether polyester trimethacrylate, polycarbonate polyether polyester trimethacrylate, polycarbonate tetraacrylate, polyether tetraacrylate, polyester tetraacrylate, polycarbonate polyether tetraacrylate, polycarbonate polyester tetraacrylate, polyether polyester tetraacrylate, polycarbonate polyether polyester tetraacrylate, polycarbonate tetramethacrylate, polyether tetramethacrylate, polyester tetramethacrylate, polycarbonate polyether tetramethacrylate, polycarbonate polyester tetramethacrylate, polyether polyester tetramethacrylate, polycarbonate polyether polyester tetramethacrylate, polycarbonate hexacrylate, polyether hexacrylate, polyester hexacrylate, polycarbonate polyether hexacrylate, polycarbonate polyester hexacrylate, polyether polyester hexacrylate, polycarbonate polyether polyester hexacrylate, polycarbonate hexamethacrylate, polyether hexamethacrylate, polyester hexamethacrylate, polycarbonate polyether hexamethacrylate, polycarbonate polyester hexamethacrylate, polyether polyester hexamethacrylate, polycarbonate polyether polyester hexamethacrylate, trimethylolpropane ethoxylate triacrylate, trimethylolpropane triacrylate, trimethylolpropane propoxylate triacrylate, glycerol propoxylate triacrylate, pentaerythritol triacrylate, zirconium bromonorbornanelactone carboxylate triacrylate, trimethylolpropane ethoxylate trimethacrylate, trimethylolpropane trimethacrylate, trimethylolpropane propoxylate trimethacrylate, glycerol propoxylate trimethacrylate, pentaerythritol trimethacrylate, zirconium bromonorbornanelactone carboxylate trimethacrylate, pentaerythritol tetraacrylate, 3-(N,N,N,N tetrakis(propionate) hexanediamino)-2-hydroxypropyl acrylate, pentaerythritol tetramethacrylate, 3-(N,N,N,N tetrakis(propionate)hexanediamino)-2-hydroxypropyl methacrylate, dipentaerythritol pentaacrylate, dipentaerythritol pentamethacrylate, dipentaerythritol hexaacrylate, dipentaerythritol hexamethacrylate, isobornyl acrylate, hexadecyl acrylate, t-butyl acrylate, silsesquioxane acrylates, methacrylic acid, methyl methacrylate, benzyl methacrylate, ethyl methacrylate, isopropyl methacrylate, hydropropyl methacrylate, isobutyl methacrylate, t-butyl methacrylate, cyclohexyl methacrylate, isobornyl methacrylate, phenyl methacrylate, trimethylsilyl methacrylate, T6 silsesquioxane methacrylate, T8 silsesquioxane methacrylate, T10 silsesquioxane methacrylate, T12 silsesquioxane methacrylate, methyl cyanoacrylate, ethyl cyanoacrylate, propyl cyanoacrylate, isopropyl cyanoacrylate, butyl cyanoacrylate, allyl cyanoacrylate, methoxyethyl cyanoacrylate, T6 silsesquioxane cyanoacrylate, T8 silsesquioxane cyanoacrylate, T10 silsesquioxane cyanoacrylate, T12 silsesquioxane cyanoacrylate, acrylamide, N,N dimethyl acrylamide, t-butyl acrylamide, styrene, methylstyrene, dimethylstyrene, trimethylstyrene, t-butyl styrene, ethoxystyrene, acetoxystyrene, methacrylonitrile, and combinations thereof.

6. The battery cell of claim 1, wherein the overmoulded housing is at most 100 mm larger than the cathode, the anode, the separator, and the gel polymer electrolyte.

7. The battery cell of claim 6, wherein the overmoulded housing is at most 0.5 mm larger than the cathode, the anode, the separator, and the gel polymer electrolyte.

8. The battery cell of claim 1, wherein the cathode, the separator, and the anode are terraced.

9. The battery cell of claim 1, wherein the battery cell comprises a non-zero radius of curvature in at least 2 orthogonal axes.

10. A method comprising:
injecting a prepolymer electrolyte into a cavity surrounding a dry battery electrode stack;
wetting the dry battery electrode stack with the prepolymer electrolyte to form a wetted battery electrode stack;
until a target morphology is achieved:
bending the wetted battery electrode stack and the prepolymer electrolyte; and
releasing strain within the wetted battery electrode stack and the prepolymer electrolyte resulting from the bending; and
curing the prepolymer electrolyte to form a cured gel electrolyte while the wetted battery electrode stack and the prepolymer electrolyte are retained in the target morphology, wherein the cured gel electrolyte preserves the target morphology of the wetted battery electrode stack by sustaining a target tensile stress, target compressive stress, and target shear stress of the wetted electrode stack.

11. The method of claim 10, further comprising, after curing the prepolymer electrolyte injection moulding a housing around the cured gel electrolyte and the wetted battery electrode stack.

12. The method of claim 11, further comprising removing the cured gel electrolyte and the wetted battery electrode stack from the cavity prior to injection moulding the housing.

13. The method of claim 11, wherein the cavity is a pouch.

14. The method of claim 11, wherein during the injection moulding the housing an injection pressure is greater than 50 psi, wherein the cured gel electrolyte and the wetted battery electrode stack do not undergo substantially any relative movement during the injection moulding.

15. The method of claim 14, wherein the injection pressure is greater than about 1000 psi.

16. The method of claim 11, wherein the injection moulding is performed at a temperature between about 100 and 350° C., wherein the cured gel electrolyte and the wetted battery electrode stack do not substantially degrade after the injection moulding process.

17. The method of claim 10, wherein the prepolymer electrolyte comprises:
a solvent selected from the group consisting of: ethylene carbonate, fluoroethylene carbonate, propylene carbonate, vinylene carbonate, trimethylene carbonate, 1,2-butylene carbonate, 2,3-butylene carbonate, trifluoropropylene carbonate, methylene ethylene carbonate, dioxazolone, hexahydroxybenzene triscarbonate, ethylenetetracarboxylic dianhydride, tetrahydroxy-1,4-benzoquinone biscarbonate, di-tert-butyl carbonate, di-tert-butyl dicarbonate, diethyl carbonate, diethyl pyrocarbonate, dimethyl carbonate, ethyl methyl carbonate, diallyl carbonate, diphenyl carbonate, methyl (2,2,2-trifluoroethyl) carbonate, bis(2,2,2-trifluoroethyl) carbonate, dimethoxyethane, diethyl ether, tetrahydrofuran (oxolane), tetraethoxymethane, tetramethoxymethane, triethyl orthoacetate, triethyl orthoformate, trimethylorthoformate, 2,2-diethoxytetrahydrofuran, methyl formate, ethyl formate, methyl propionate, methyl butanoate, ethyl formate, ethyl acetate, ethyl propionate, propyl formate, propyl acetate, propyl proprionate, and combinations thereof;
a salt selected from the group consisting of: lithium hexafluorophosphate, lithium hexafluoroarsenate, lithium tetrafluoroborate, lithium chlorate, lithium 2,3,7,8-tetraoxo-1,4,6,9-tetraoxa-5-boraspiro[4.4]nonan-5-uide, lithium difluorophosphate, lithium bis(fluorosulfonyl)imide, lithium bis(trifluoromethanesulfonyl)imide, lithium-cyclo-difluoromethane-1,1-bis(sulfonyl)imide, lithium fluoromalonato (difluoro) borate, lithium trifluoromethanesulfonate, lithium tetraoxo-1,4,6,9-tetraoxa-5-boraspiro[4,4]nonan-5-uide, lithium trifluoro[(trifluoromethansulfonylazanidyl)sulfonyl]methane, lithium nitrate, lithium 2,2-difluoro-4,5-dioxo-1,3,2-dioxaborolane-2-uide, and combinations thereof;
an additive selected from the group consisting of: trivinylcyclotriboroxane, VC, LiDFOB, LiBOB, sulfone, ethyl methyl sulfone, tetramethyl sulfone, prop-1-ene-1,3-sulfone, 1,3-propane sultone, cyclic sulfate, lactic acid O-carboxyanhydride, dioxolone, 5-methyl-4-((trifluoromethoxy)methyl)-1,3-dioxol-2-one, phenyl boronic acid glycol ester, 5-methyl-4-((trimethylsilyloxy)methyl)-1,3-dioxol-2-one, trimethylphosphate, triethylphosphate, tributylphosphate, triphenylphosphate, tris(2,2,2-trifluoroethyl)phosphate, methyl P,P-bis(2,2,2-trifluoroethyl)phosphate, trimethylphosphite, tris(2,2,2-trifluoroethyl)phosphite, dimethyl methyl phosphate, diethyl ethylphosphate, bis(2,2,2-trifluoroethyl)methylphosphate, bis(2,2,2-trifluoroethyl)ethylphosphate, hexa(methoxy)cyclotriphosphazene, (ethoxy)pentafluorocyclotriphosphazene, (phenoxy)pentafluorocyclotriphosphazene, and combinations thereof; and
a monomer selected from the group consisting of: polycarbonate diureido diacrylate, polyether diureido diacrylate, polyester diureido diacrylate, polycarbonate polyether diureido diacrylate, polycarbonate polyester diureido diacrylate, polyether polyester diureido diacrylate, polycarbonate polyether polyester diureido diacrylate, polyether polyester diureido dimethacrylate, polycarbonate polyether polyester diureido dimethacrylate, polycarbonate diureido dimethacrylate, polyether diureido dimethacrylate, polyester diureido dimethacrylate, polycarbonate polyether diureido dimethacrylate, polycarbonate polyester diureido dimethacrylate, polycarbonate triureido triacrylate, polyether triureido triacrylate, polyester triureido triacrylate, polycarbonate polyether triureido triacrylate, polycarbonate polyester triureido triacrylate, polyether polyester triureido triacrylate, polycarbonate polyether polyester triureido triacrylate, polycarbonate triureido trimethacrylate, polyether triureido trimethacrylate, polyester triureido trimethacrylate, polycarbonate polyether triureido trimethacrylate, polycarbonate polyester triureido trimethacrylate, polyether polyester triureido trimethacrylate, polycarbonate polyether polyester triureido trimethacrylate,polycarbonate tetraaureido tetracrylate, polyether tetraaureido tetracrylate, polyester tetraaureido tetracrylate, polycarbonate polyether tetraaureido tetracrylate, polycarbonate polyester tetraaureido tetracrylate, polyether polyester tetraaureido tetracrylate, polycarbonate polyether polyester tetraaureido tetracrylate, polyether polyester tetraureido tetramethacrylate, polycarbonate polyether polyester tetraureido tetramethacrylate, polycarbonate tetraureido tetramethacrylate, polyether tetraureido tetramethacrylate, polyester tetraureido tetramethacrylate, polycarbonate polyether tetraureido tetramethacrylate, polycarbonate polyester tetraureido tetramethacrylate, polycarbonate hexaaureido hexacrylate, polyether hexaaureido hexacrylate, polyester hexaaureido hexacrylate, polycarbonate polyether hexaaureido hexacrylate, polycarbonate polyester hexaaureido hexacrylate, polyether polyester hexaaureido hexacrylate, polycarbonate polyether polyester hexaaureido hexacrylate, polyether polyester hexaureido hexamethacrylate, polycarbonate polyether polyester hexaureido hexamethacrylate, polycarbonate hexaureido hexamethacrylate, polyether hexaureido hexamethacrylate, polyester hexaureido hexamethacrylate, polycarbonate polyether hexaureido hexamethacrylate, polycarbonate polyester hexaureido hexamethacrylate, polycarbonate diacrylate, polyether diacrylate, polyester diacrylate, polycarbonate polyether diacrylate, polycarbonate polyester diacrylate, polyether polyester diacrylate, polycarbonate polyether polyester diacrylate, polycarbonate dimethacrylate, polyether dimethacrylate, polyester dimethacrylate, polycarbonate polyether dimethacrylate, polycarbonate polyester dimethacrylate, polyether polyester dimethacrylate, polycarbonate polyether polyester dimethacrylate, polycarbonate triacrylate, polyether triacrylate, polyester triacrylate, polycarbonate polyether triacrylate, polycarbonate polyester triacrylate, polyether polyester triacrylate, polycarbonate polyether polyester triacrylate, polycarbonate trimethacrylate, polyether trimethacrylate, polyester trimethacrylate, polycarbonate polyether trimethacrylate, polycarbonate polyester trimethacrylate, polyether polyester trimethacrylate, polycarbonate polyether polyester trimethacrylate, polycarbonate tetraacrylate, polyether tetraacrylate, polyester tetraacrylate, polycarbonate polyether tetraacrylate, polycarbonate polyester tetraacrylate, polyether polyester tetraacrylate, polycarbonate polyether polyester tetraacrylate, polycarbonate tetramethacrylate, polyether tetramethacrylate, polyester tetramethacrylate, polycarbonate polyether tetramethacrylate, polycarbonate polyester tetramethacrylate, polyether polyester tetramethacrylate, polycarbonate polyether polyester tetramethacrylate, polycarbonate hexacrylate, polyether hexacrylate, polyester hexacrylate, polycarbonate polyether hexacrylate, polycarbonate polyester hexacrylate, polyether polyester hexacrylate, polycarbonate polyether polyester hexacrylate, polycarbonate hexamethacrylate, polyether hexamethacrylate, polyester hexamethacrylate, polycarbonate polyether hexamethacrylate, polycarbonate polyester hexamethacrylate, polyether polyester hexamethacrylate, polycarbonate polyether polyester hexamethacrylate, trimethylolpropane ethoxylate triacrylate, trimethylolpropane triacrylate, trimethylolpropane propoxylate triacrylate, glycerol propoxylate triacrylate, pentaerythritol triacrylate, zirconium bromonorbornanelactone carboxylate triacrylate, trimethylolpropane ethoxylate trimethacrylate, trimethylolpropane trimethacrylate, trimethylolpropane propoxylate trimethacrylate, glycerol propoxylate trimethacrylate, pentaerythritol trimethacrylate, zirconium bromonorbornanelactone carboxylate trimethacrylate, pentaerythritol tetraacrylate, 3-(N,N,N,N tetrakis(propionate)hexanediamino)-2-hydroxypropyl acrylate, pentaerythritol tetramethacrylate, 3-(N,N,N,N tetrakis(propionate) hexanediamino)-2-hydroxypropyl methacrylate, dipentaerythritol pentaacrylate, dipentaerythritol pentamethacrylate, dipentaerythritol hexaacrylate, dipentaerythritol hexamethacrylate, and combinations thereof.

18. The method of claim 17, wherein the prepolymer electrolyte further comprising:
an inhibitor selected from the group consisting of phenothiazine, butylated hydroxytoluene, hydroquinones, 4-methoxyphenol, monobenzone, hydroquinone, guaiacol, 2-hydroxy-5-methoxybenzaldehyde, 1,2-benzoquinone, 1,4-benzoquinone, 1,4-naphthoquinone, 9,10-anthraquinone, chloranil, quinone methide, p-phenylenediamines, diethylhydroxylamine, hydroxylhydroxylamine, (2,2,6,6-Tetramethylpiperidin-1-yl)oxyl (TEMPO), 4-hydroxy-TEMPO, and combinations thereof: and
an initiator selected from the group consisting of: 1-1′-azobis(cyclohexanecarbonitrile), 2,2′-azobisisobutyronitrile, 2,2-Bis(tert-butylperoxy) butane, 1,1-bis(tert-butylperoxy)cyclohexane, 2,2′-azobis[2-(2-imidazolin-2-yl)-propane]dihydrochloride, 2,5-bis(tert-butylperoxy)-2,5-dimethylhexane, 2,5-bis(tert-butylperoxy)-2,5-dimethyl-3-hexyne, bis(1-(tertbutylperoxy)-1-methylethyl)benzene, 1,1-bis(tert-butylperoxy)-3,3,5-trimethylcyclohexane, tert-butyl peracetate, tert-butyl hydroperoxide, cumene hydroperoxide, di-tert-butyl peroxide, tert-butyl peroxybenzoate, tert-butylperoxyisopropyl carbonate, dicumyl peroxide, benzoyl peroxide, lauroyl peroxide, 2,4-pentanedione peroxide, peracetic acid, tert-amyl peroxybenzoate, 4,4-azobis(4-cyanovaleric acid), 1,1′-azobis(cyclohexanecarbonitrile), ammonium persulfate, potassium persulfate (or other persulfate salts), lauroyl peroxide, tert-butyl peroxide, tert-butyl peroxybenzoate, benzoyl peroxide, phenylbis(2,4,6-trimethylbenzoyl) phosphine oxide), 2,2-dimethoxy-2-phenylacetophenone, and combinations thereof.

19. The method of claim 18, wherein the prepolymer electrolyte comprises about 5-80% by mass of the solvent, about 5-20% by mass of the salt, about 0.01-10% by mass of the additive, about 10-80% by mass of the monomer, about 0.001-5% by mass of the inhibitor, about 0.001-5% by mass of the initiator, wherein the total percentage adds up to 100%.

20. The method of claim 10, wherein curing the prepolymer electrolyte comprises thermally treating the prepolymer electrolyte to initiate a polymerization reaction.
